(19) United States
(12) Patent Application Publication
(10) Pub. No.: US 2017/0296307 A1
(43) Pub. Date: Oct. 19, 2017

(54) DENTAL IMPLANT SYSTEM

(71) Applicant: Grant Dental Technology Corporation, Colorado Springs, CO (US)

(72) Inventors: Earl Wayne Simmons, Colorado Springs, CO (US); James Grant, Colorado Springs, CO (US); Richard Victor Denton, Colorado Springs, CO (US); Duncan Howard Stewart, Colorado Springs, CO (US); Douglas James Brooke, Colorado Springs, CO (US)

(73) Assignee: Grant Dental Technology Corporation, Colorado Springs, CO (US)

(21) Appl. No.: 15/640,351

(22) Filed: Jun. 30, 2017

Related U.S. Application Data
(63) Continuation-in-part of application No. 14/642,565, filed on Mar. 9, 2015, now Pat. No. 9,737,376.
(60) Provisional application No. 61/949,908, filed on Mar. 7, 2014.

(51) Int. Cl. A61C 8/00

(52) U.S. Cl. CPC A61C 8/0074; A61C 8/008; A61C 8/0025; A61C 8/0045; A61C 8/0068

(57) ABSTRACT

A dental implant whereby an osteotomy cavity is formed in jawbone and then a base member of the implant is positioned into the cavity. The base member serves as a platform to secure an abutment member of the implant that in turn receives a dental restoration, such as a crown or denture.

### CROSS-REFERENCE TO RELATED APPLICATION

This application is a continuation-in-part of U.S. Ser. No. 14/642,565 filed Mar. 9, 2015 titled “Eccentric Dental Implant System,” which application claims the benefit of U.S. Prov. Pat. App. Ser. 61/949,908, filed 7 Mar. 2014, the entirety of each of which is hereby incorporated by reference for all purposes.

### BACKGROUND

Implants are a popular means of or for replacing a tooth. Due to their relatively low maintenance and durability, people increasingly prefer implants to bridges or dentures. Nevertheless, there remain significant complications that are the result of using a round implant in a jawbone space that formerly had a non-round or eccentric tooth, and is therefore undersized in one or more horizontal dimensions in relation to the tooth it would replace. These complications include food impaction, bacteria collection, and excessive stress on bone and implant components.

### SUMMARY

A dental implant that includes or comprises an eccentrically-shaped base member, an endosseous implant body, and an eccentrically-shaped abutment member. In practice, the base member is fitted to or positioned within an eccentrically-shaped osteotomy box or cavity formed within the jawbone. Following the osteotomy and the insertion of the base member, a pilot hole is drilled within the jawbone, and the endosseous implant body is positioned through a central passage formed within the base member and then is torqued into place to rigidly secure the base member to the jawbone. Then, the abutment member is fitted to the base member. In some examples, the central passage formed within the base member is tapered to match a taper of the head of the endosseous implant body. In so doing, a friction fit or cold weld is formed between the endosseous implant body and the base member. Additionally, in some examples, the central passage formed within the base member includes an internal thread that is complementary to an external thread of the endosseous implant body. In so doing, the friction fit or cold weld formed between the endosseous implant body and the base member is securely held in place. Although not so limited, and appreciation of the various aspects of the present disclosure may be gained from the following discussion in connection with the drawings.

### DESCRIPTION OF THE DRAWINGS

A further understanding of the aspects of the disclosure may be realized by reference to the following figures. In the figures, similar components or features may have the same reference label. Further, various components of the same type may be distinguished by immediately following the reference label with a second label that distinguishes among the similar components. When only the first reference label is used in the specification, the description is applicable to any one of the similar components having the same first reference label irrespective of whether the second reference label is recited.

FIGS. 1A-B each show a perspective view of an example assembled dental implant.

FIGS. 2A-B show a side view of the implant of FIGS. 1A-B.

FIGS. 3A-B show another side view of the implant of FIGS. 1A-B.

FIGS. 4A-B show a bottom view of the implant of FIGS. 1A-B.

FIGS. 5A-B show a top view of the implant of FIGS. 1A-B.

FIGS. 6A-B show another side view of the implant of FIGS. 1A-B.

FIGS. 7A-B show another side view of the implant of FIGS. 1A-B.

FIGS. 8A-B show a cross-section of the side view of FIGS. 7A-B.

FIGS. 9A-B show an exploded view of the implant of FIGS. 1A-B.

FIGS. 10A-B show a first screw of the implant of FIGS. 1A-B.

FIGS. 11A-B show a top view of the screw of FIGS. 10A-B.

FIGS. 12A-B show a bottom view of the screw of FIGS. 10A-B.

FIGS. 13A-B show an abutment of the implant of FIGS. 1A-B.

FIGS. 14A-B show a top view of the abutment of FIGS. 13A-B.

FIGS. 15A-B show a bottom view of the abutment of FIGS. 13A-B.

FIGS. 16A-B show another screw of the implant of FIGS. 1A-B.

FIGS. 17A-B show a top view of the screw of FIGS. 16A-B.

FIGS. 18A-B show a bottom view of the screw of FIGS. 16A-B.

FIGS. 19A-B show a base of the implant of FIGS. 1A-B.

FIG. 19C shows an alternate base member with ridges and having differing internal and external cross sections.

FIG. 19D shows a base member with different internal and external cross sections and an anti-rotation placement tool in use.

FIGS. 20A-B show a top view of the base of FIGS. 19A-B.

FIGS. 21A-B show a bottom view of the base of FIGS. 19A-B.

FIGS. 22A-B show certain components of FIGS. 8A-B.

FIGS. 23A-D show other certain components of FIGS. 8A-B.

FIG. 24 shows a modification to the base of FIG. 19A.

FIG. 25 shows a modification to the abutment of FIG. 13A.

FIG. 26 shows an implant site with a tissue former in place.

FIG. 27 shows an implant having a surgical cover (also referred to as a healing cap) in place.

FIG. 28 illustrates a top plan view of either of the base members of FIG. 19C or 19D, showing differing internal and external cross-sections.

FIG. 29A shows a side cross sectional view of a base member embodiment having a two-stage angled upper face.

FIG. 29B shows the base member of FIG. 29A with an abutment being positioned therein.

FIG. 30A shows a side cross sectional view of an alternate base member embodiment having an upwardly angled upper face.

FIG. 30B shows the base member of FIG. 30A with an abutment being positioned therein.

### DETAILED DESCRIPTION

When placing a dental implant as discussed throughout, a space or osteotomy cavity is formed in jawbone and then a base member is positioned into the space. In general, the base member serves as a platform to secure an abutment that in turn receives a dental restoration, such as a crown or denture. In one aspect, the outer cross-section of the base member is eccentric in cross-section. The term “eccentric” is used herein to mean non-circular and non-radially symmetric. Eccentric includes “rounded” or “soft” triangular shapes, “rounded” or “soft” rectangular shapes, “rounded” or “soft” square shapes, “rounded” or “soft” trapezoidal shapes, any “rounded” or “soft” polygonal shape, an oval or elliptical shape, or any other appropriate shape. The edges are generally intended to be “rounded” or “soft,” similar to tooth curvatures. Providing an eccentric external cross-section prevents the base member from rotating within bone, due to its eccentric shape. The base member may have a relatively large surface area that is in contact with or integrated into the jawbone, and this decreases stress on the bone, implant, abutment, and crown. In another aspect, the base member has a recess that receives the bottom end of the abutment, which is shaped to match the non-circular and non-radially symmetric geometry of the base member. This provides a precise friction connection for the physician to position the implant within the base in a correct orientation, prevents the abutment from rotating relative to the base member, creates a tight seal, and distributes forces throughout the connected pieces.

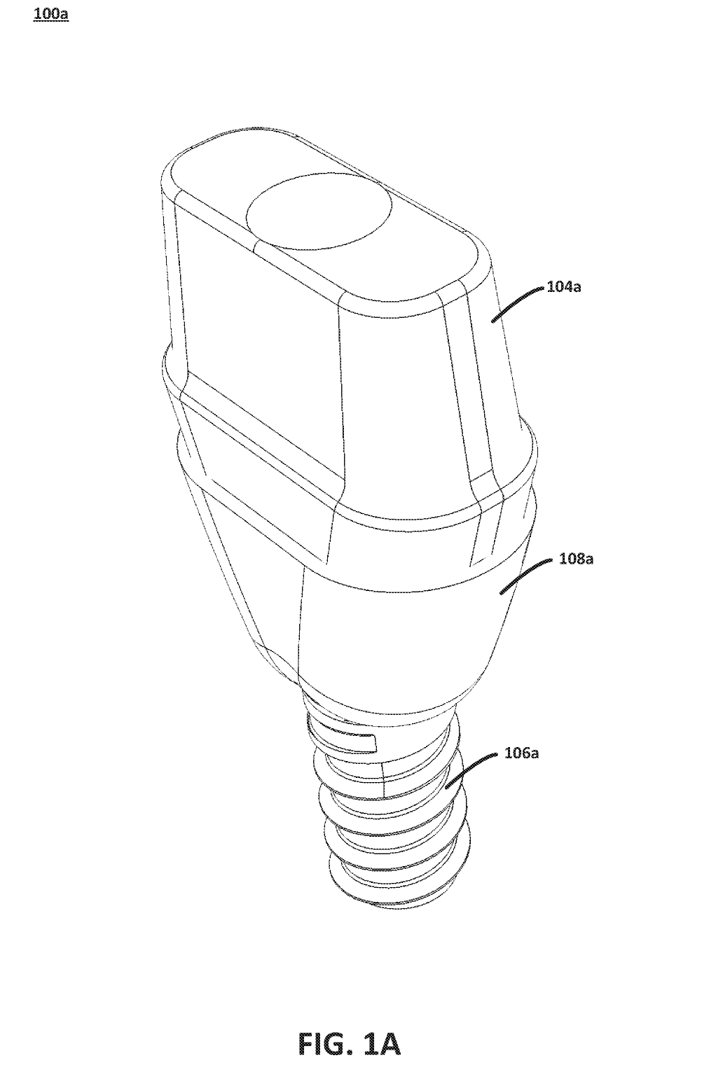

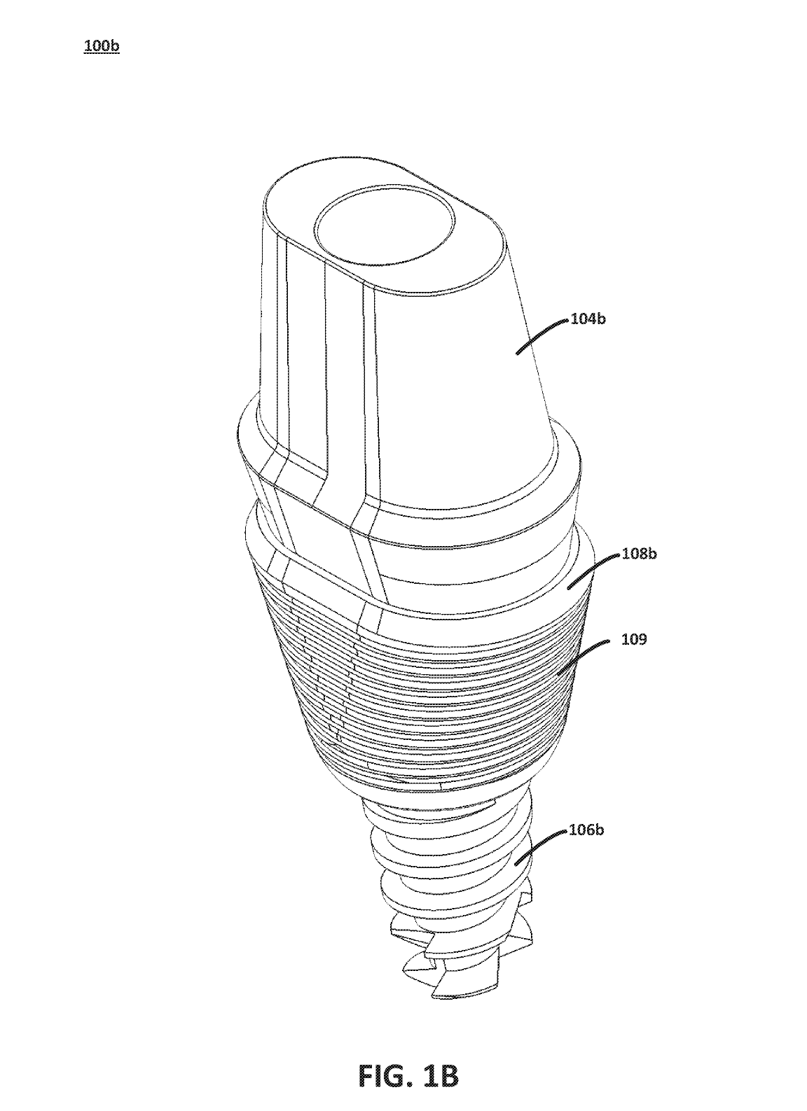

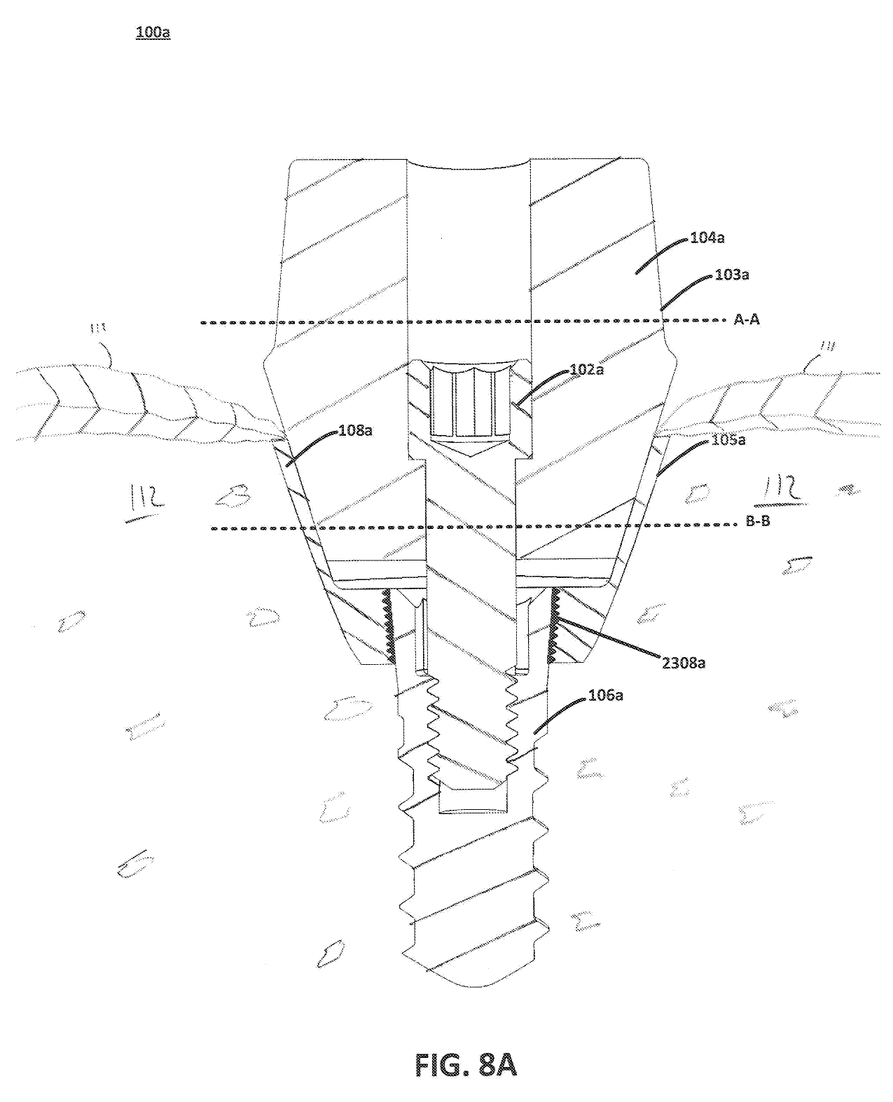

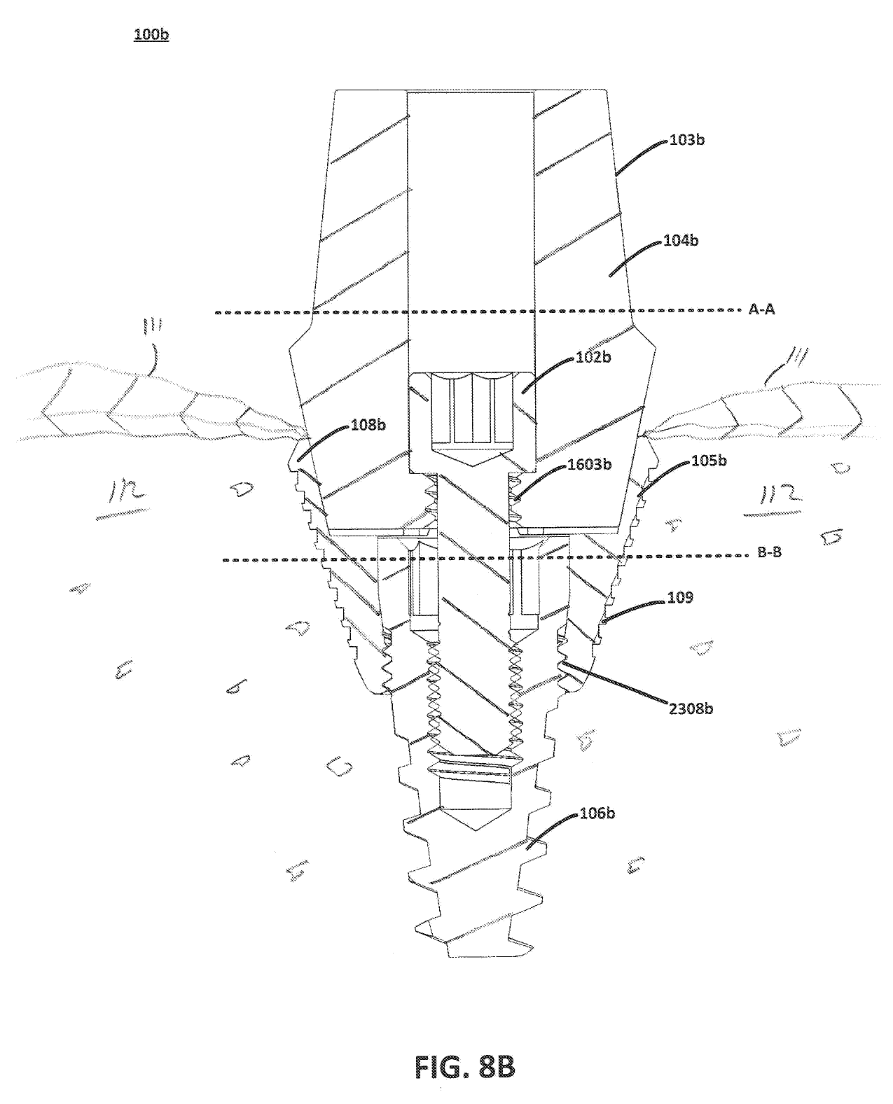

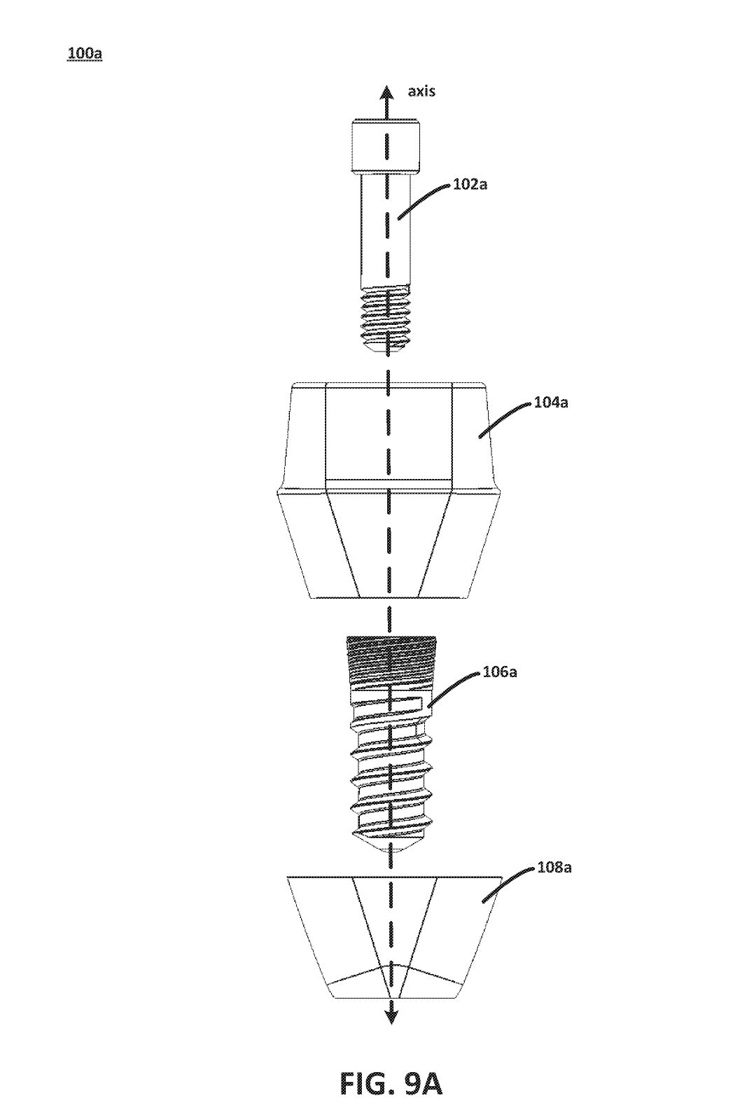

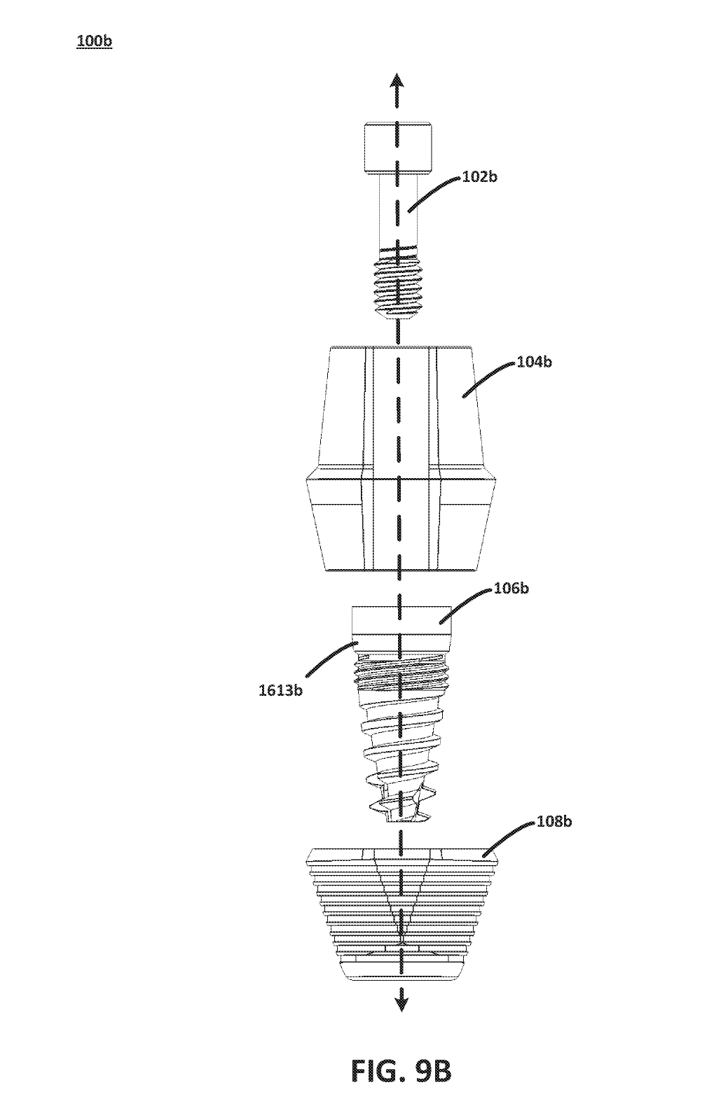

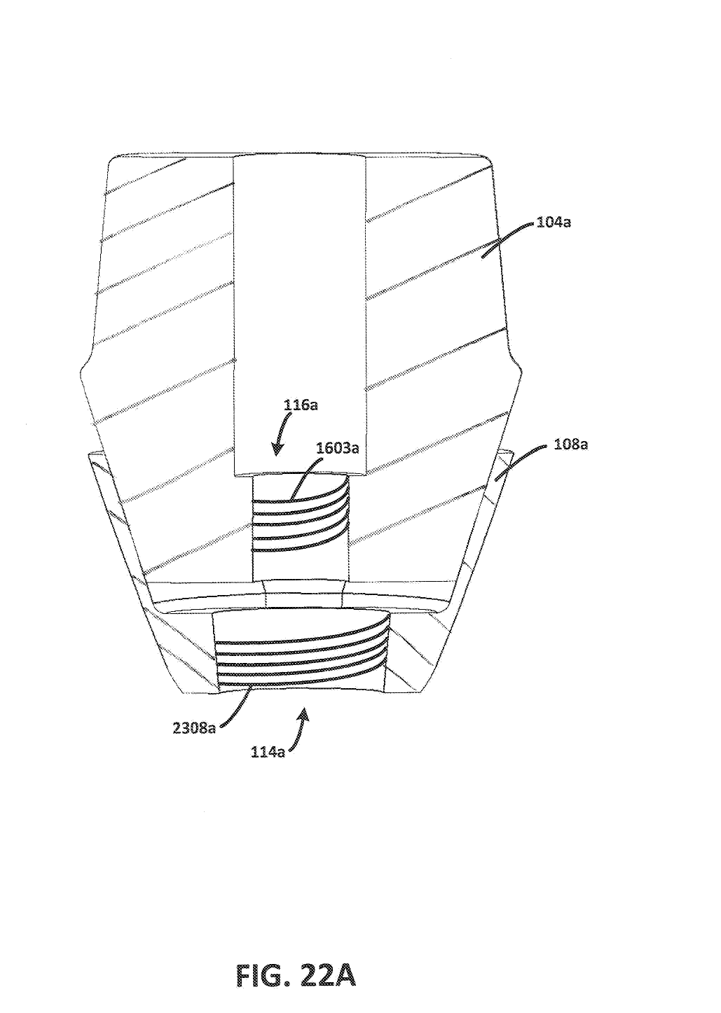

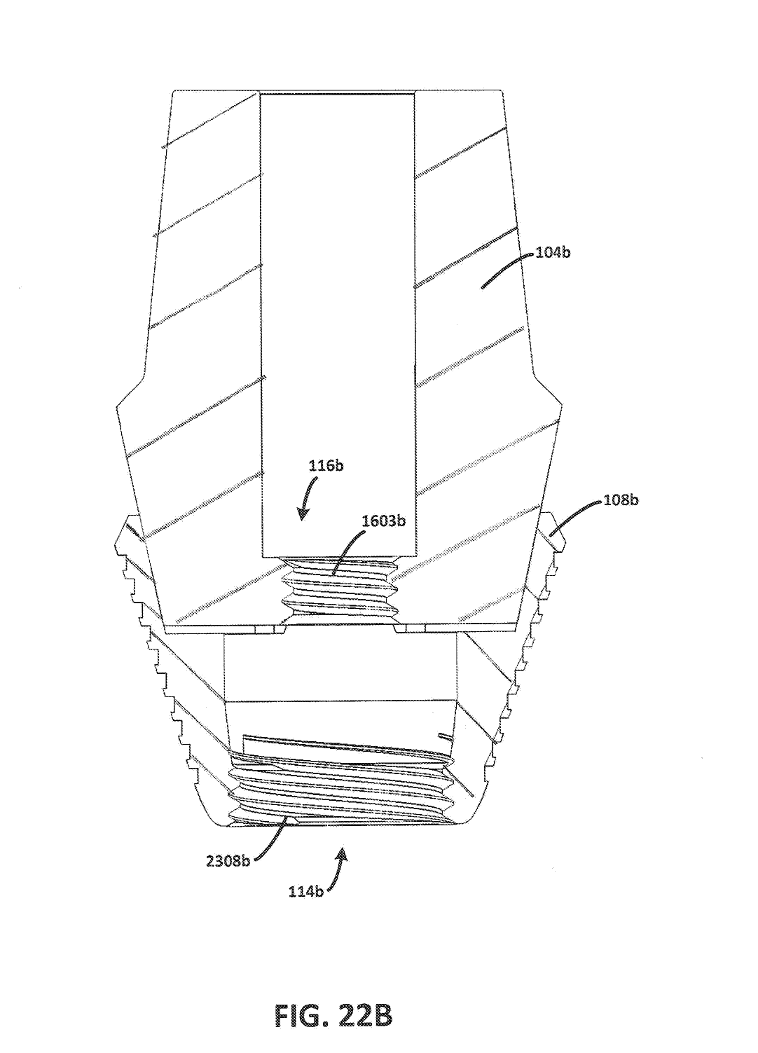

Referring now to FIGS. 1A-B through FIGS. 9A-B, and most specifically to FIGS. 8A-B and FIGS. 9A-B, an example dental implant 100(a,b) is shown in accordance with the present disclosure. The dental implant 100 includes or comprises a fastener 102(a,b), an abutment member 104(a,b), an endosseous implant body 106(a,b), and a base member 108(a,b). In practice, the base member 108 is fitted to or positioned within an eccentrically-shaped (e.g., oval-like) osteotomy box or cavity 110 formed within jawbone 112, shown in FIGS. 8A-B in exaggerated and simplified view. We note that the outer dimensions and shape of the abutment member 104(a,b) where it is inserted into the base member 108(a,b) can be designed to be closely aligned with the base member dimensions (generally called platform matching), or the outer dimensions of the abutment can be slightly smaller than the base member while generally following the shape of the base member (generally called platform switching). The tissue 111 is folded back to carry out the osteotomy that is to accommodate the base member 108(a,b). This may involve drilling of a small pilot hole within the jawbone 112 for carrying out the osteotomy. Then, the base member 108(a,b) is inserted. A pilot hole is further drilled with base member already in place as a guide, for subsequent insertion of the endosseous implant body 106. The endosseous implant body 106 is positioned through a central passage 114(a,b), shown FIGS. 22A-B, formed within the base member 108 and then is torqued into place to rigidly secure the base member 108 to the jawbone 112. In some examples, the central passage 114 is tapered and matches a taper in the head of endosseous implant body 106. In so doing, a friction fit or cold weld is formed between the endosseous implant body 106 and the base member 108 similar to that described in U.S. Pat. Nos. 8,562,244 and 8,740,616, incorporated herein by reference.

In some examples, the central passage 114 includes threads that interact or mate with corresponding threads in the head of the endosseous implant body 106 to create a tightly sealed connection whereby the endosseous implant body 106 and surfaces of the central passage 114 are cinched tightly together. More specifically, the threaded connection between the endosseous implant body 106 and the base member 108 serves to maintain the friction fit or cold weld between the tapered sections so as to prevent micro-leakages between the two components. Although a threaded connection is shown and described, it should be understood that this connection could also be cemented, cold welded, or use any other appropriate attachment technique. These connections may be used with or without a threaded connection. The abutment member 104 may then be fitted to or positioned within the base member 108. The fastener 102 may then be positioned through an internal passage 116(a,b), shown FIGS. 22A-B, formed within the abutment member 104 and then may be torqued into place within a receiver 118(a,b), also shown FIGS. 22A-B, formed within the endosseous implant body 106, to rigidly secure the abutment member 104 to the base member 108. As may be understood upon inspection of FIGS. 1A-B through FIGS. 9A-B, and in particular FIGS. 8A-B, any particular cross-section A-A of the abutment member 104, and any particular cross-section B-B of the base member 108, is non-circular or eccentric in that an outer surface 103(a-b) of the abutment member 104 when viewed in cross-section would exhibit a non-circular or eccentric shape, and similarly an outer surface 105(a-b) of the abutment member 104 when viewed in cross-section would exhibit a non-circular or eccentric shape.

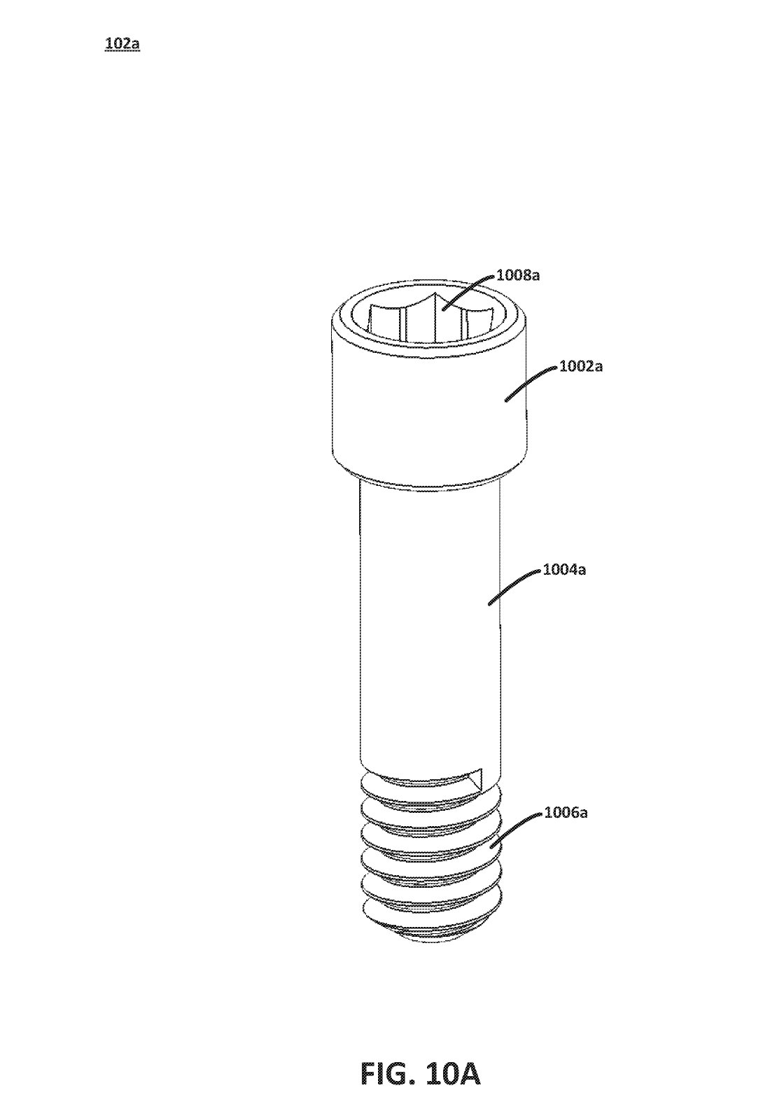

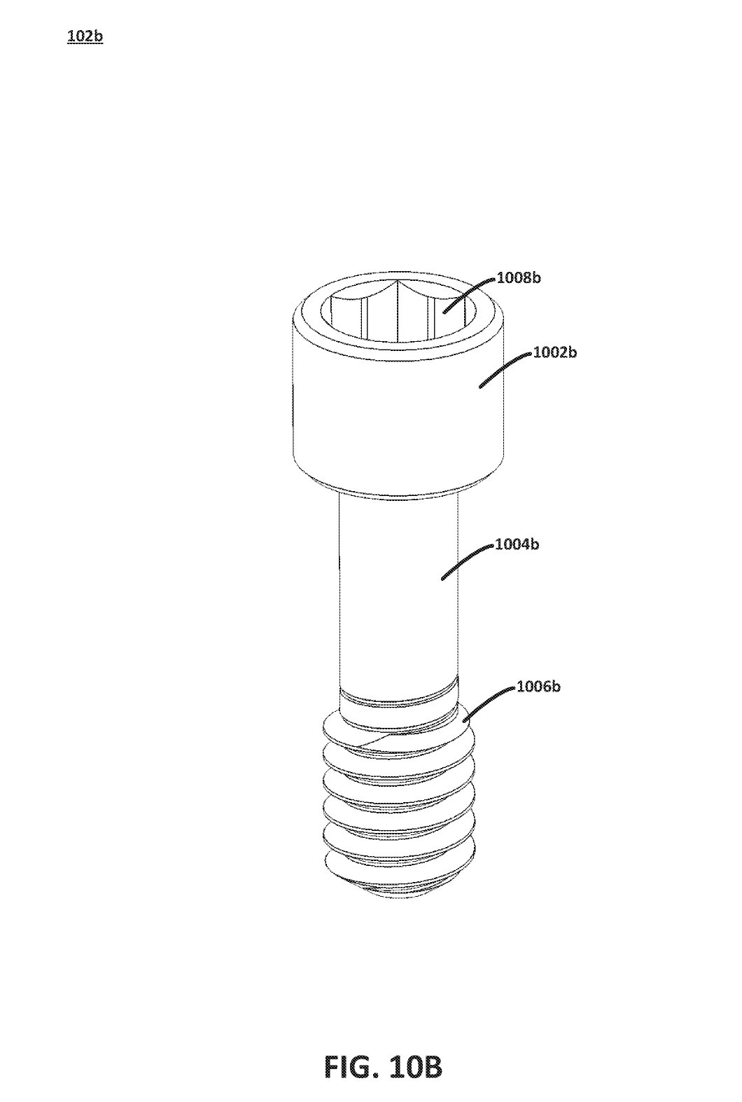

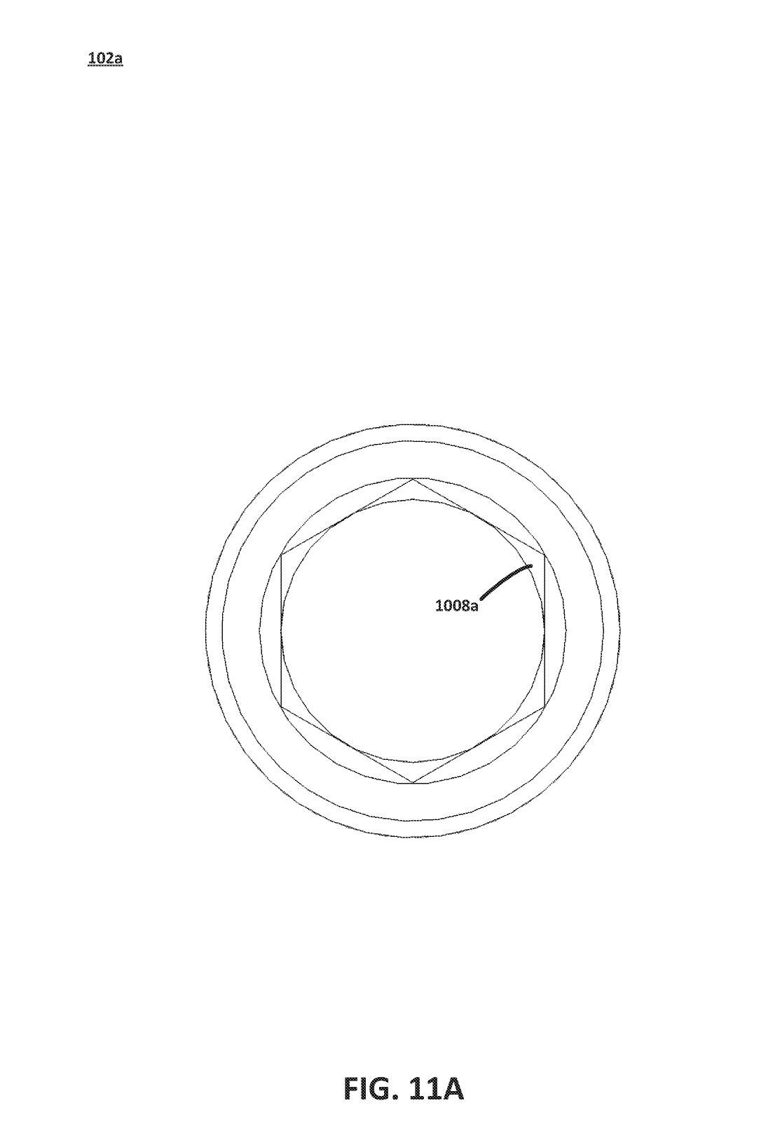

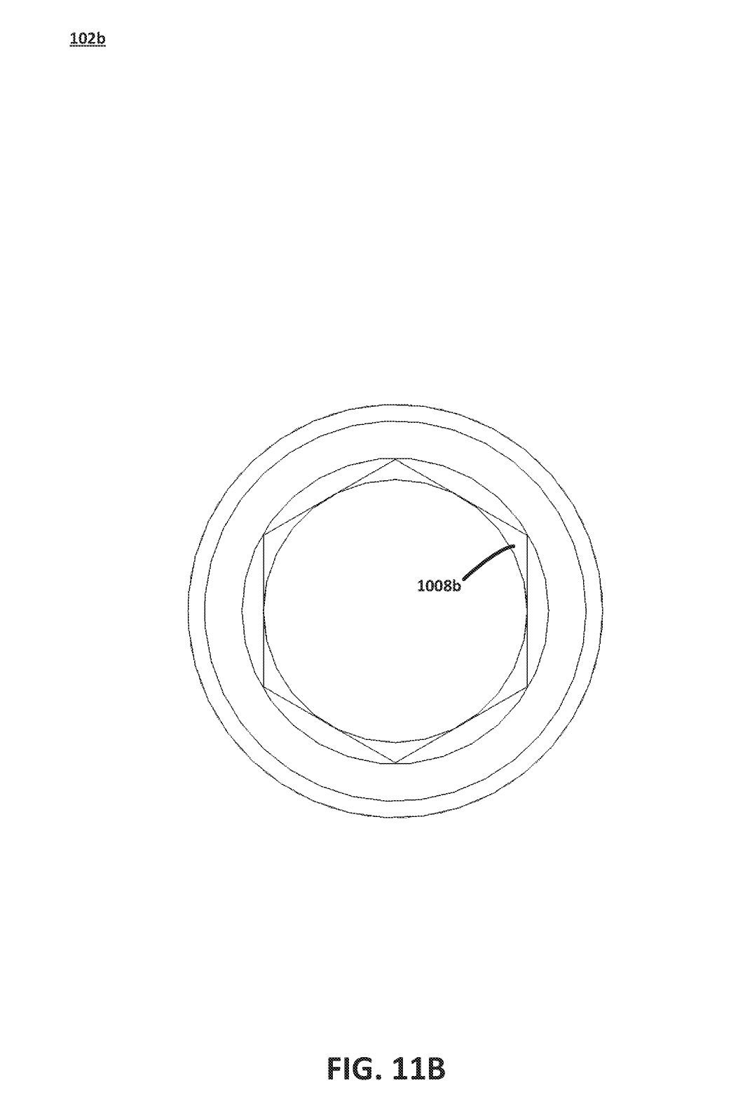

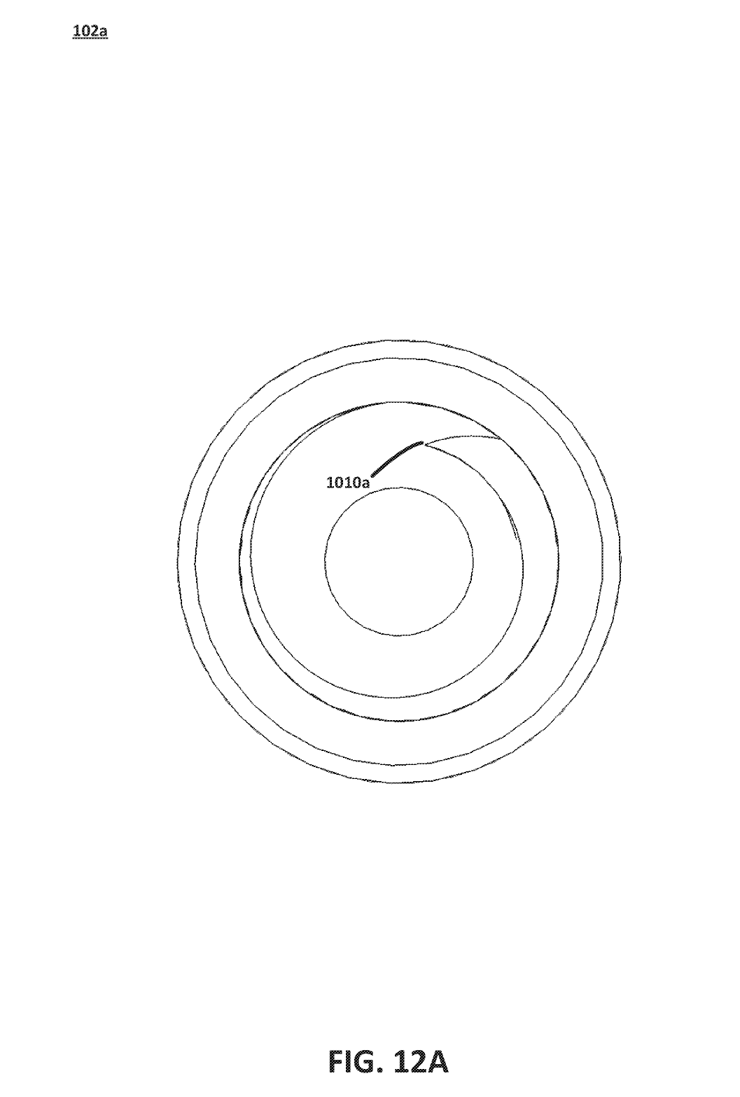

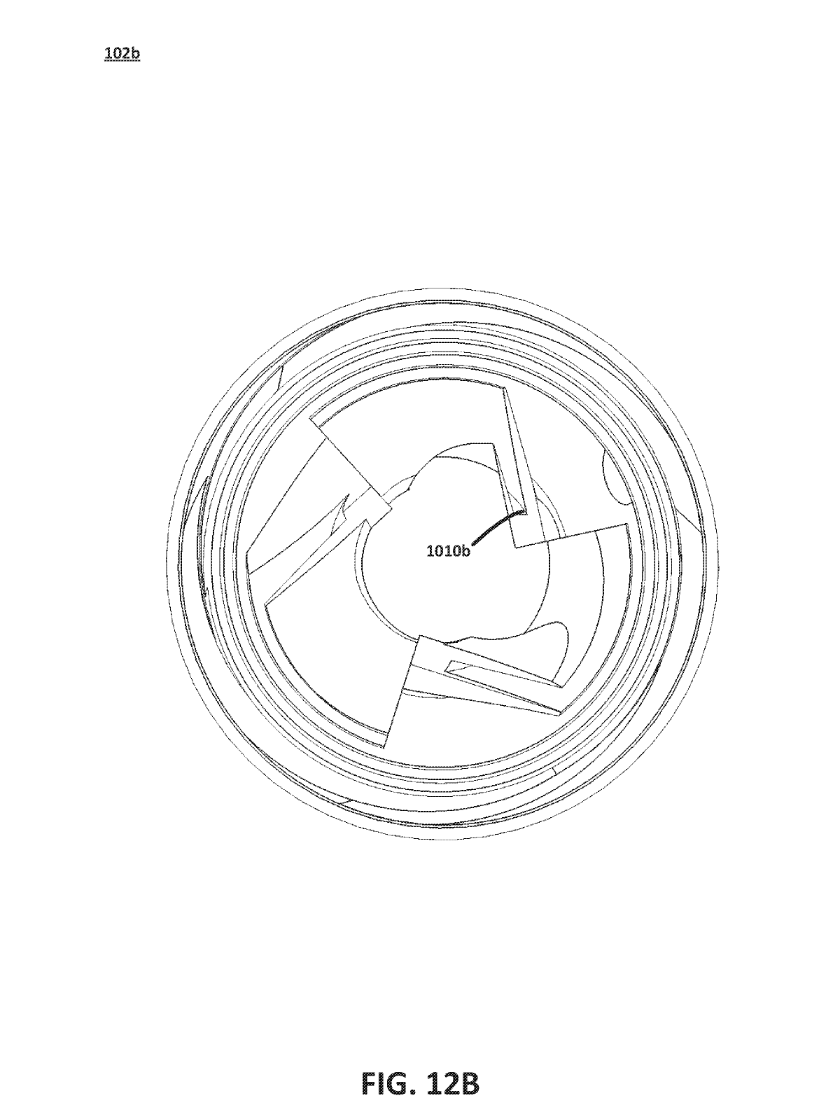

Referring now to FIGS. 10A-B through FIGS. 12A-B, multiple views of the fastener 102 are shown in accordance with the present disclosure. In this example, the fastener 102 includes a head portion 1002(a,b), a shank portion 1004(a,b), and a thread portion 1006(a,b). The head portion 1002 is an extension of the shank portion 1004, and includes a keyed-aperture 1008(a,b) that provides a bearing surface(s) for a tip or bit of a torque-applying tool (not shown). The thread portion 1006 is formed within the shank portion 1004 and includes at least one leading edge 1010(a,b), shown in FIGS. 12A-B. In comparison, the thread portion 1006a has an OD (Outer Diameter) that substantially or approximately matches an OD of the shank portion 1004a, whereby the thread portion 1006b has an OD that is greater than an OD of the shank portion 1004b. Additionally, the thread portion 1006 may be tapered so that an OD of the thread portion 1006 near the leading edge 1010 is less than an OD of the thread portion 1006 at an end of the thread portion 1006 opposite the leading edge 1010. The OD of the thread portion 1006 may be measured with respect to a longitudinal axis of the fastener 102 and the dental implant 100 as shown in FIGS. 9A-B. In some examples, the fastener 102 may be formed of zirconia or titanium or sapphire material. Other examples are possible.

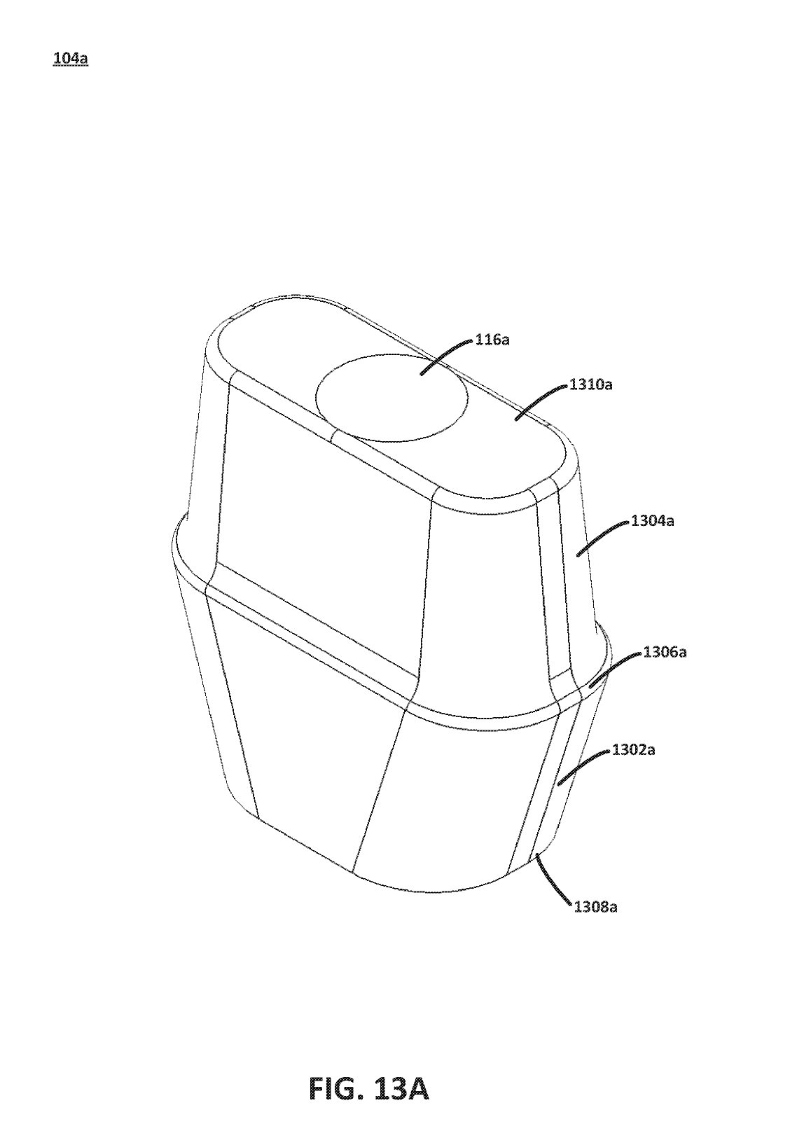

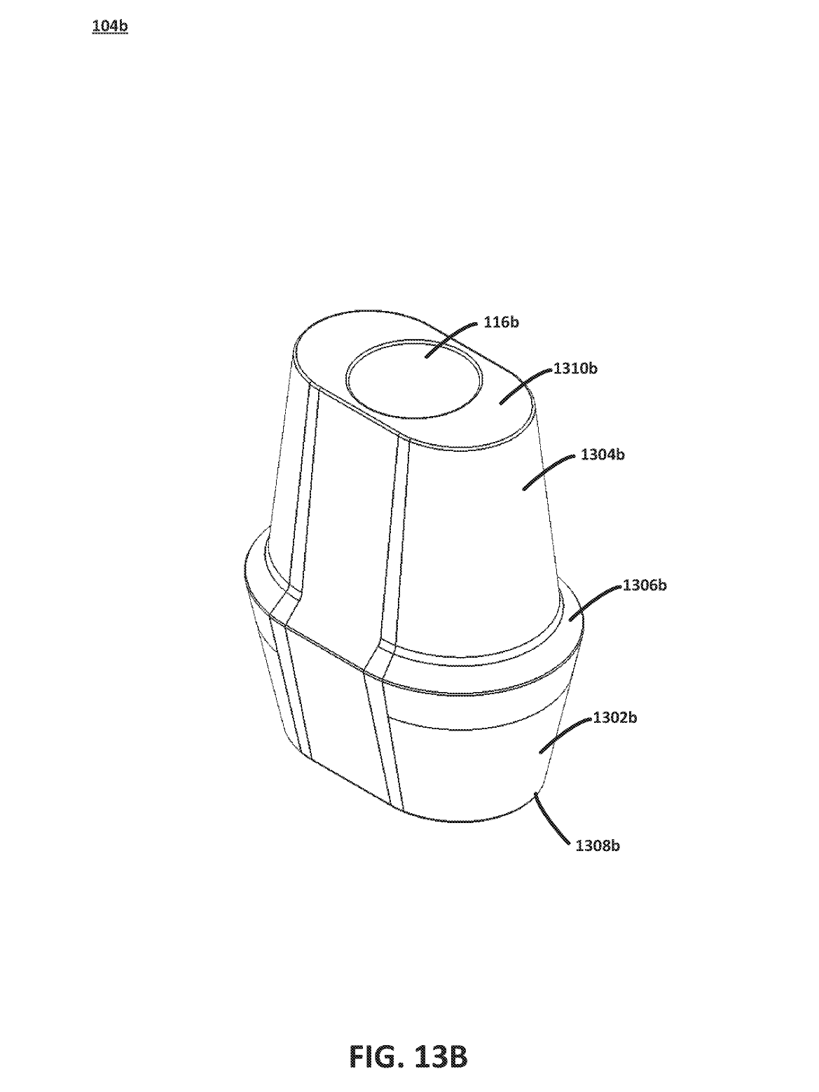

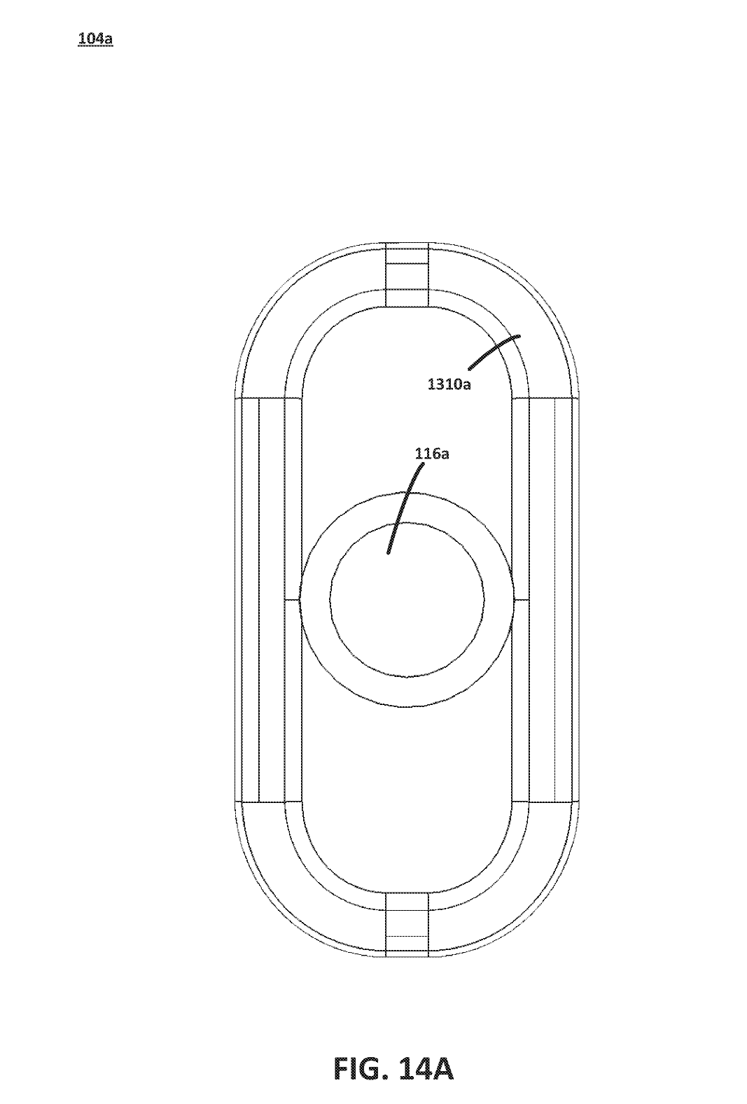

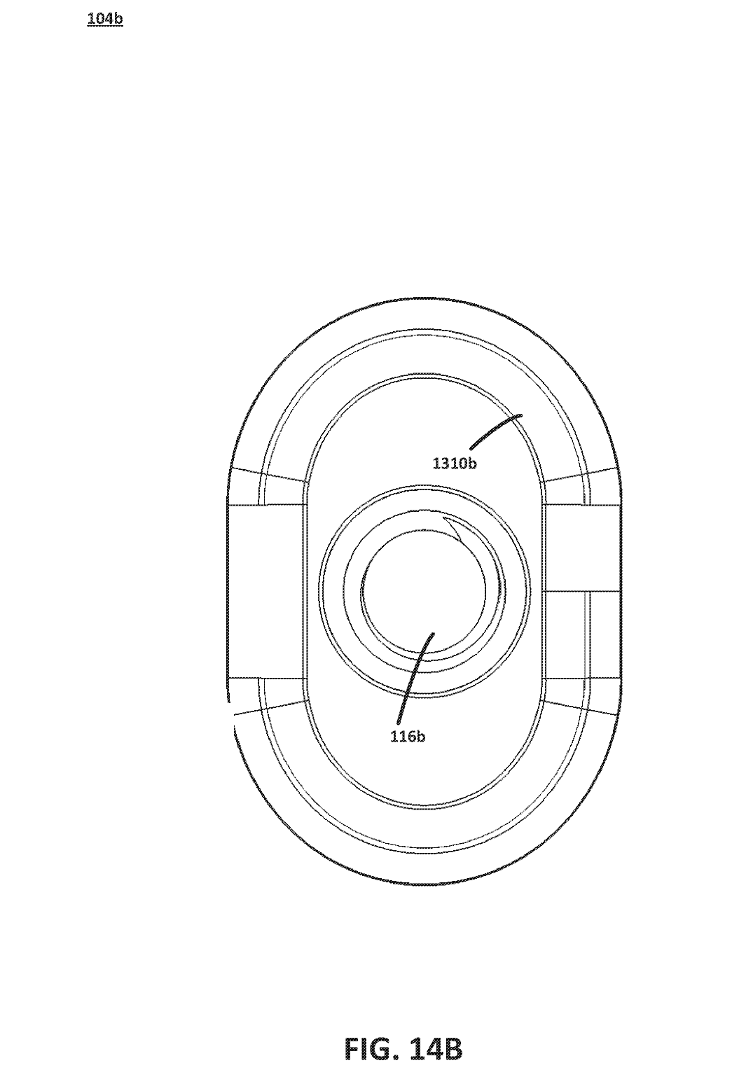

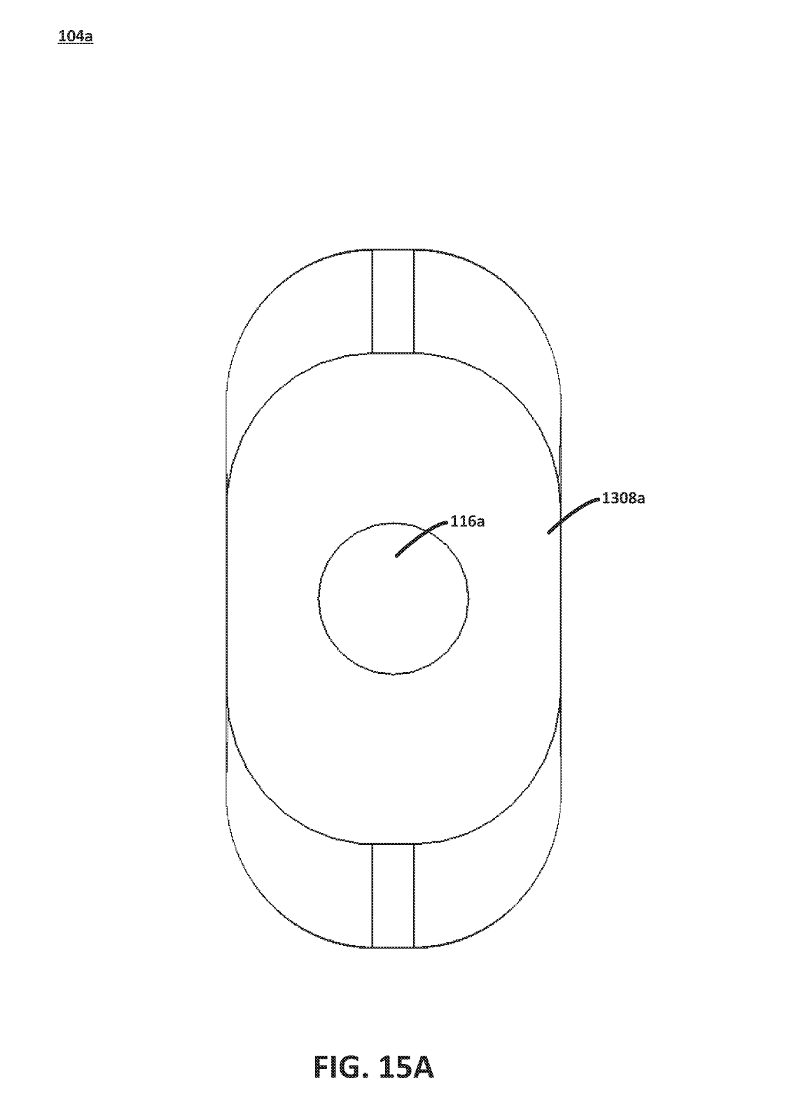

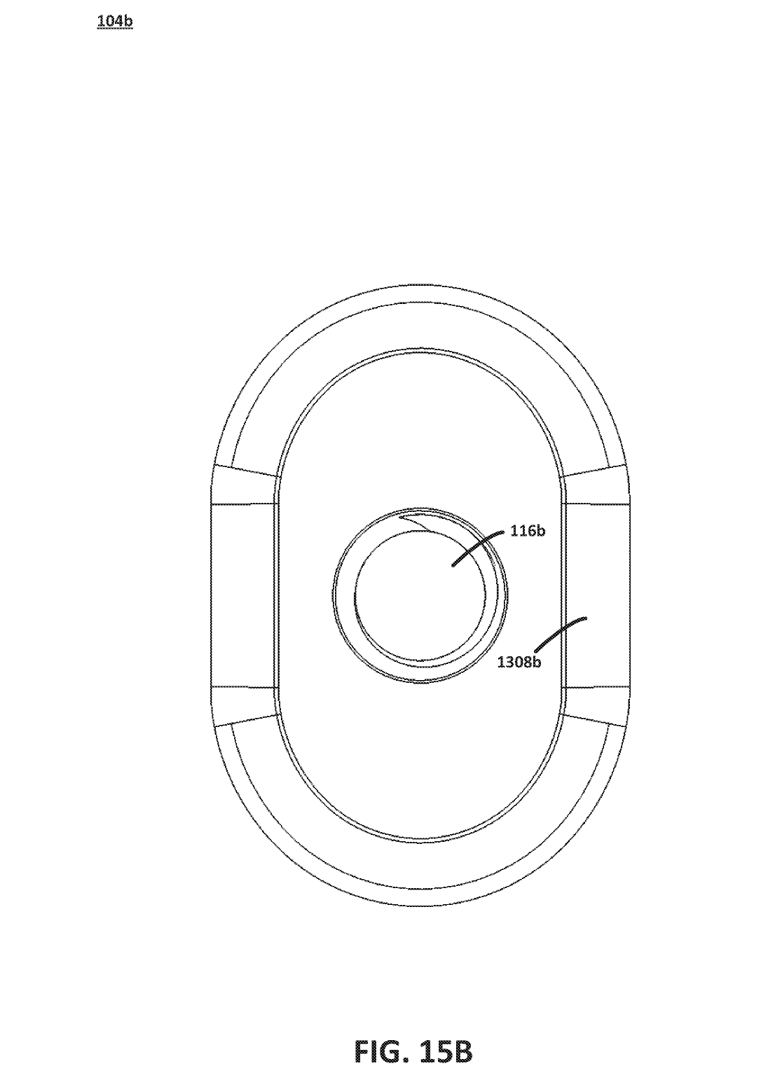

Referring now to FIGS. 13A-B through FIGS. 15A-B, multiple views of the abutment member 104 are shown in accordance with the present disclosure. In this example, and as mentioned above, an internal passage 116 is formed within the abutment member 104. The internal passage 116 is shaped so that the fastener 102 may be positioned thereto, and then torqued into place within the receiver 118b that is formed within the endosseous implant body 106. The abutment member 104 further exhibits external features including a first portion 1302(a,b) and a second portion 1304(a,b) separated by a flared ridge 1306(a,b). The first portion 1302 tapers inwardly as measured with respect to a longitudinal axis of the abutment member 104 and the dental implant 100 as shown in FIGS. 9A-B, starting from the ridge 1306 moving towards an end 1308(a,b) of the first portion 1302 opposite the ridge 1306. Similarly, the second portion 1304 tapers inwardly as measured with respect to the longitudinal axis of the abutment member 104, starting from the ridge 1306 moving towards an end 1310(a,b) of the second portion 1304 opposite the ridge 1306. FIGS. 14A-B and FIGS. 15-B show the non-circular, oblong, or oval shape of the ends 1308, 1310 of the example abutment member 104. In general, the shape of the ends 1308, 1310 may be defined so as to match the shape of portions of the base member 108, to prevent rotation of the abutment member 104 when positioned to the base member 108, and also provide a mechanism to easily lock the abutment member 104 in place. Other shapes of the abutment member 104 (and base member 108) are possible.

For example, the ends 1308, 1310 of the abutment member 104 may exhibit any polygonal shape as desired, or other irregular shapes such as a double-lobe or “Figure 8” and/or a lemniscate shape. Other examples are possible. For example, it is contemplated that one or more features or elements of the abutment member 104, base member 108, etc., may be formed to exhibit a non-round asymmetrical shape. Further, in some examples, the abutment member 104 may be formed of a white zirconia material to more closely match crown coloring. In some examples, dimensions of the abutment member 104 may be in a range from about 5.0 millimeters to about 12.0 millimeters inclusive in total height, and various combinations of dimensions at the rim ranging from about 4.0 millimeters to about 10.0 millimeters inclusive.

In one embodiment, the abutment may be provided with internal threading at its bottom (the abutment bottom). This allows the pre-insertion and threading of the securing screw into the abutment and prevents the surgeon from losing the screw from the abutment when transporting the component to and from the surgical site. This provides a safety feature; the securing screws are very small and have the potential to be aspirated or swallowed accidentally. The upper shaft of the abutment securing screw may have a smooth wall, which can eliminate any thread timing problems with the lower internal threads of the endosseous implant body, as it engages and is torqued down.

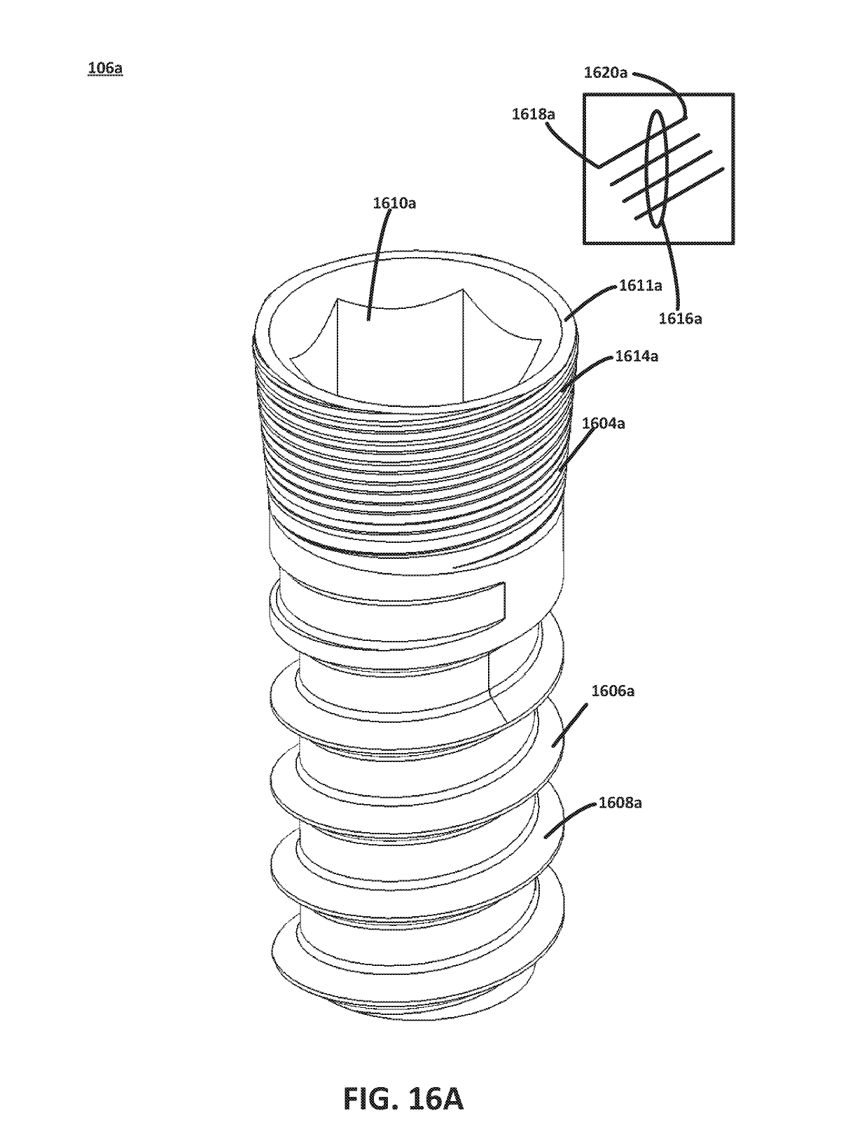

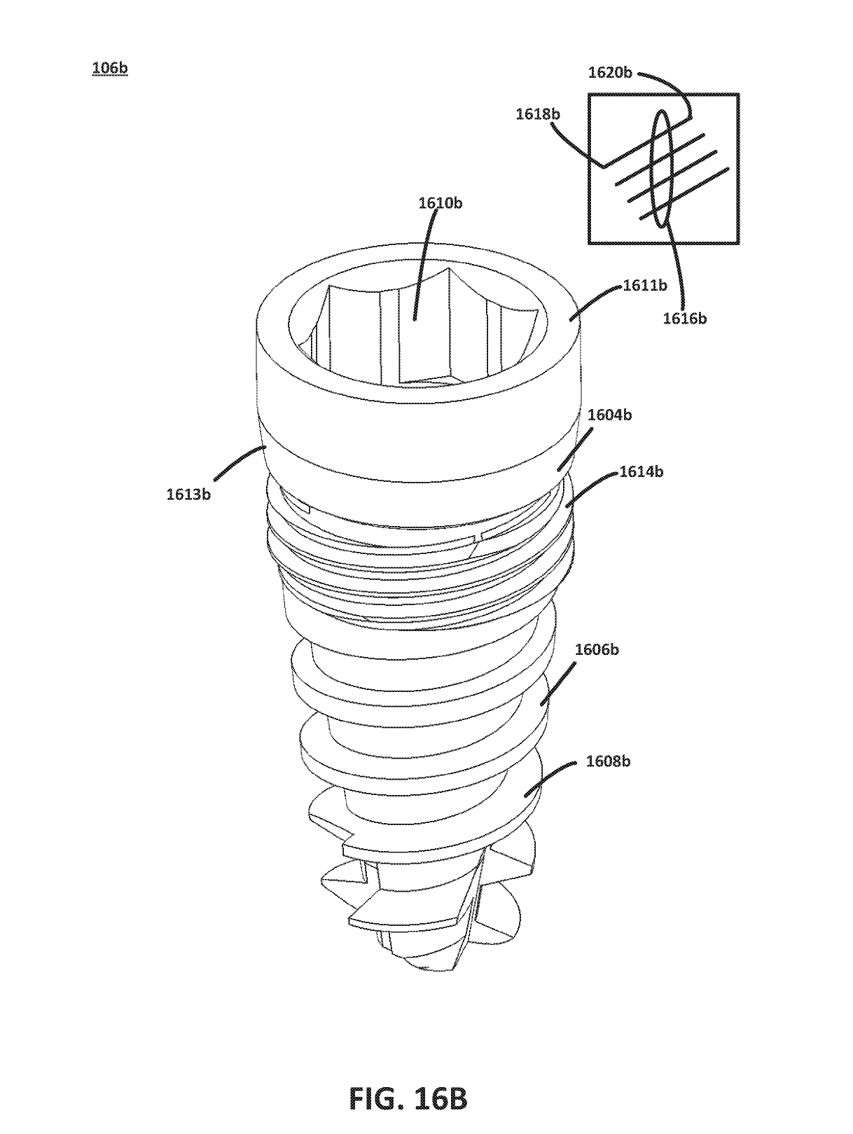

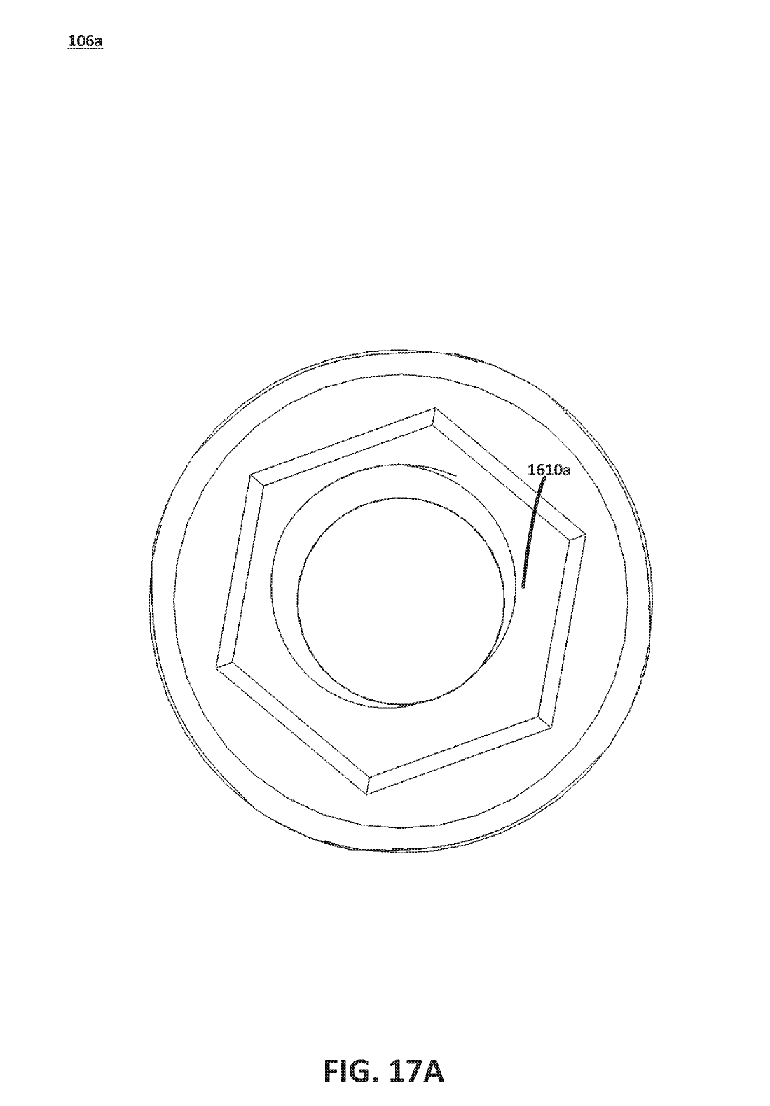

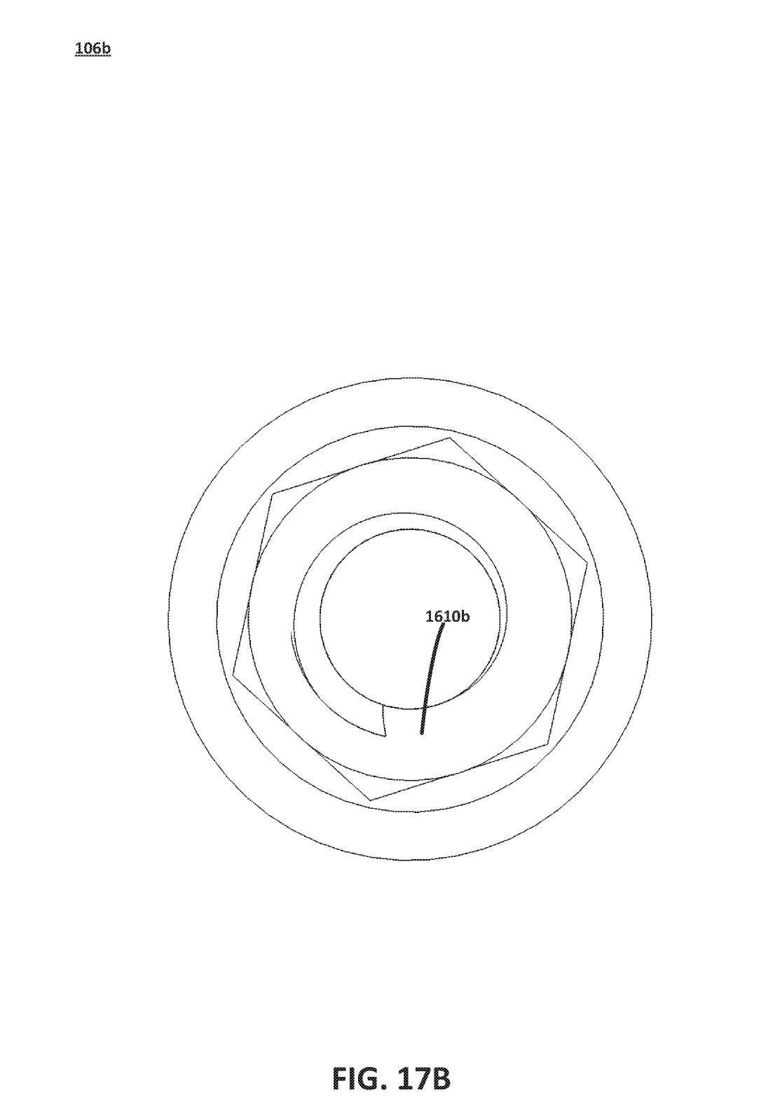

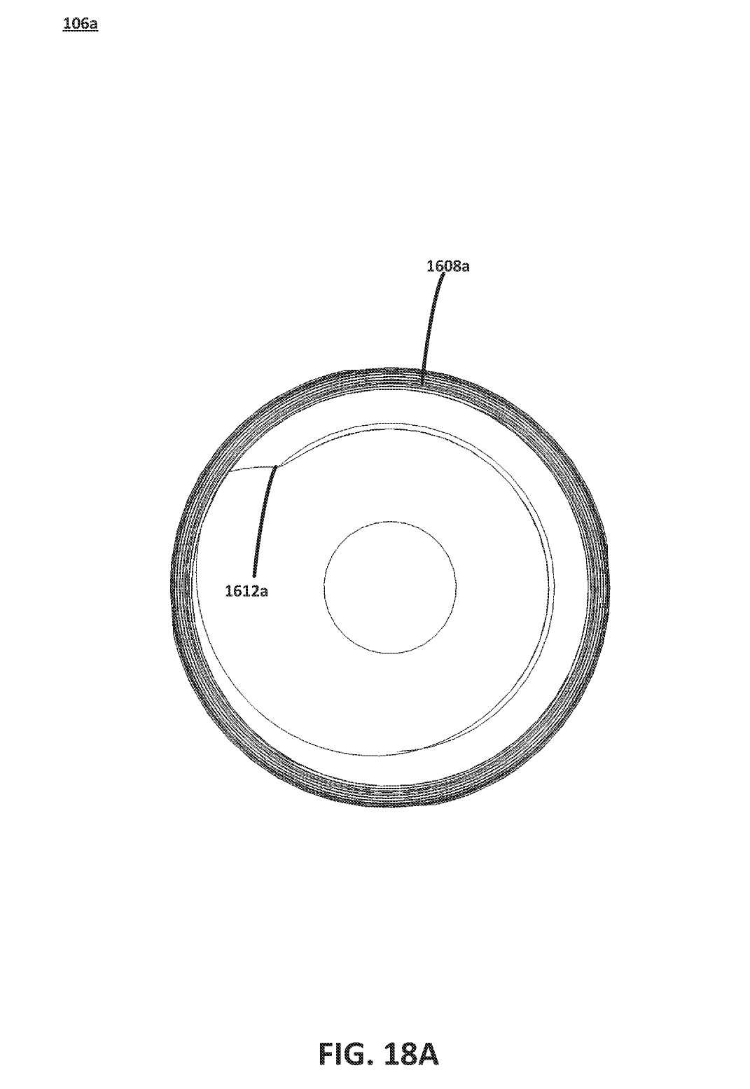

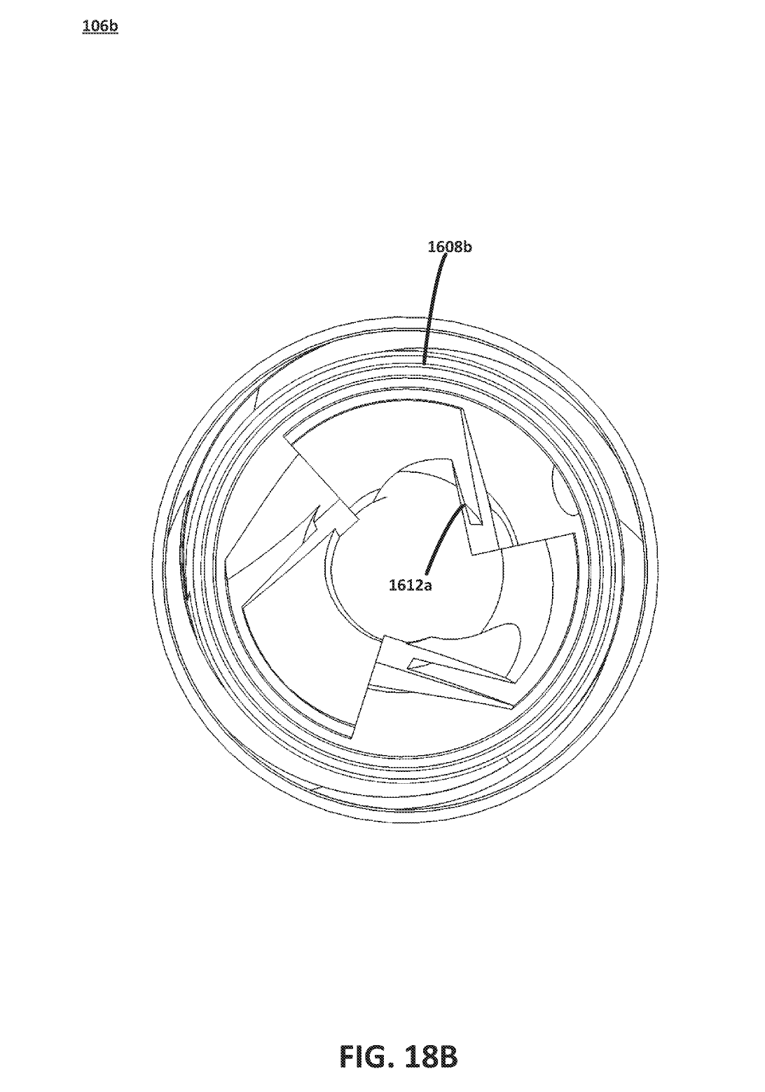

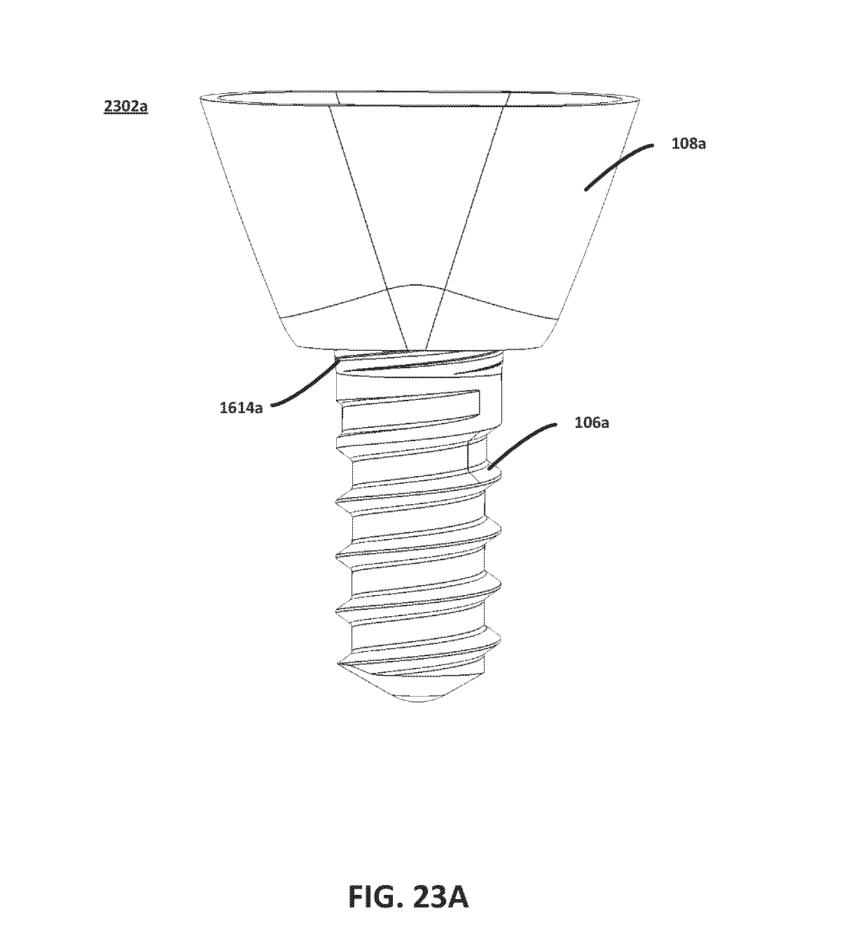

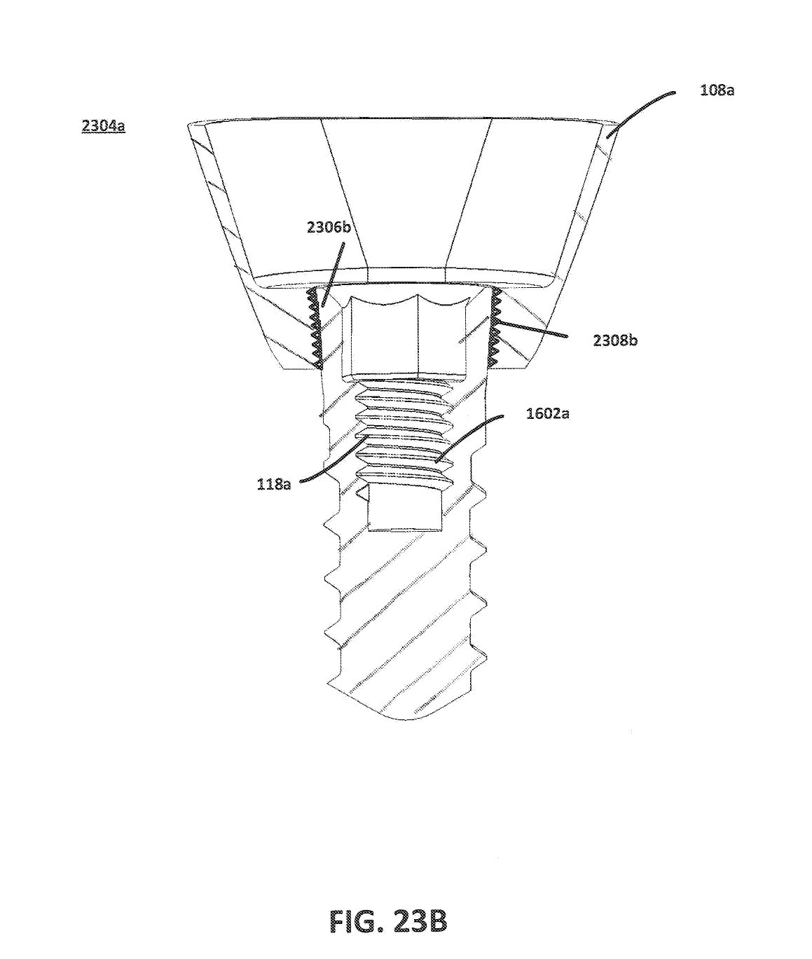

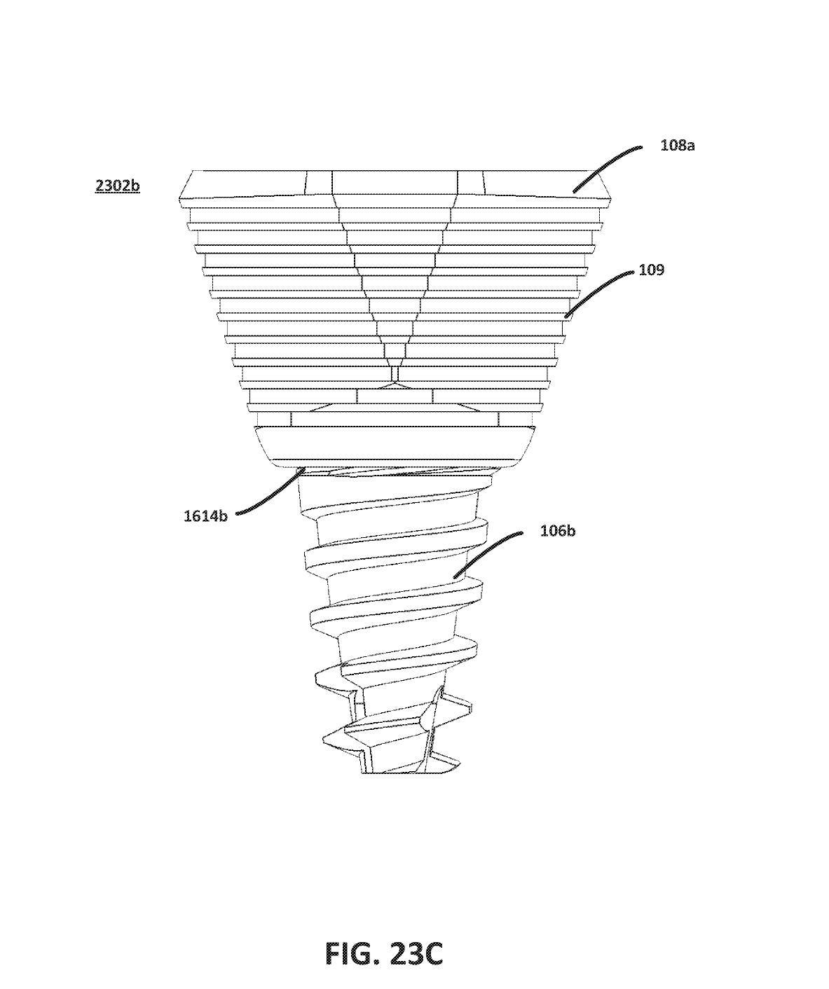

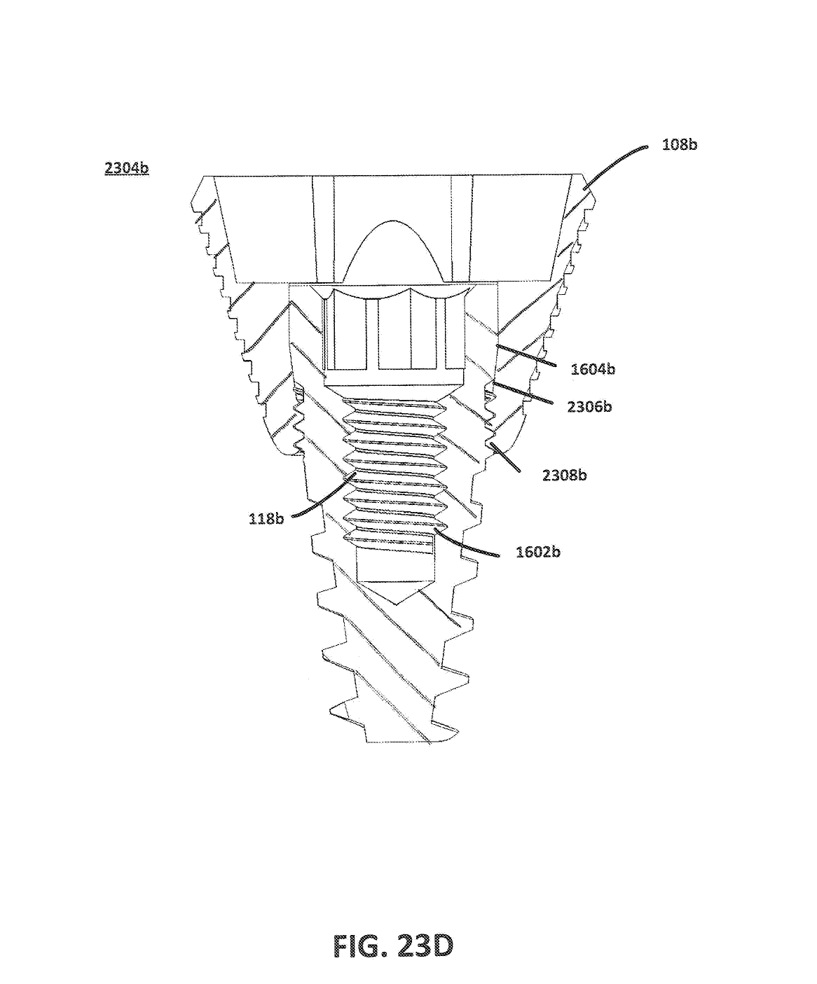

Referring now to FIGS. 16A-B through FIGS. 18A-B, multiple views of the endosseous implant body 106 are shown in accordance with the present disclosure. In this example, and as mentioned above, a receiver 118b is formed within the endosseous implant body 106. Referring additionally to FIGS. 23A-D, the receiver 118 is shaped to include a female thread 1602(a,b) so that the thread portion 1006 of the fastener 102 may be threaded thereto. Referring additionally to FIGS. 22A-B, the internal passage 116 formed within the abutment member 104 is shaped to include a female thread 1603(a,b) so that the thread portion 1006 of the fastener 102 may be positioned and threaded thereto. Additionally, the endosseous implant body 106 exhibits a number of features similar to the fastener 102. For example, the endosseous implant body 106 includes a head portion 1604(a,b), a shank portion 1606(a,b), and a thread portion 1608(a,b). The head portion 1604 is an extension of the shank portion 1606, and includes a keyed-aperture 1610(a,b) that provides a bearing surface(s) for a tip or bit of a torque-applying tool. Further, the thread portion 1608 is formed within the shank portion 1606 and includes at least one leading edge 1612 as shown in FIGS. 18A-B. The head portion 1604 of the endosseous implant body 106 though includes an external feature different than the head portion 1002 of the endosseous implant body 106.

In particular, the head portion 1604 includes an external thread 1614(a,b), whereby each level or full turn of the external thread 1614 includes multiple open leads. This is illustrated in FIGS. 16A-B where the head portion 1604 is projected onto a plane to show a number of individual threads 1616(a,b) of the external thread 1614, whereby each one of the individual threads 1616 includes a first end or open lead 1618(a,b) and terminates in a second end or open lead 1620(a,b). In general, this is an optional feature, where the head portion 1604 does not necessarily have to include the external thread 1614, but when does so the external thread 1614 in general may exhibit a pitch different than thread portion 1608. Additionally, it is contemplated that the external thread 1614 may be formed at any position along a length of the endosseous implant body 106. For example, the external thread 1614a is shown immediately adjacent to a top edge 1611a of the endosseous implant body 106 in FIG. 16A, whereas the external thread 1614b is shown offset from a top edge 1611b of the endosseous implant body 106 in FIG. 16B.

Additionally, the external thread 1614 may not necessarily be formed of multiple open leads, and instead may be formed of a single thread with only first and second open ends. Additionally, the head portion 1604 of the endosseous implant body 106 may taper inwardly as measured with respect to a longitudinal axis of the endosseous implant body 106 as shown in FIGS. 9A-B, starting from an end associated with the keyed aperture 1610 moving towards the thread portion 1608. As discussed further below, the base member 108 includes features that are complementary to the external features of the head portion 1604. In some examples, the endosseous implant body 106 may be formed of a titanium, zirconia, or sapphire material. In some examples, dimensions of the endosseous implant body 106 may be in a range from about 3.0 millimeters to about 5.0 millimeters in diameter inclusive, and in a range from about 8.0 millimeters to about 16.0 millimeters in length inclusive. In some examples, a taper angle of the head portion 1604 may be in a range from about 1.0 degrees to about 15.0 degrees inclusive.

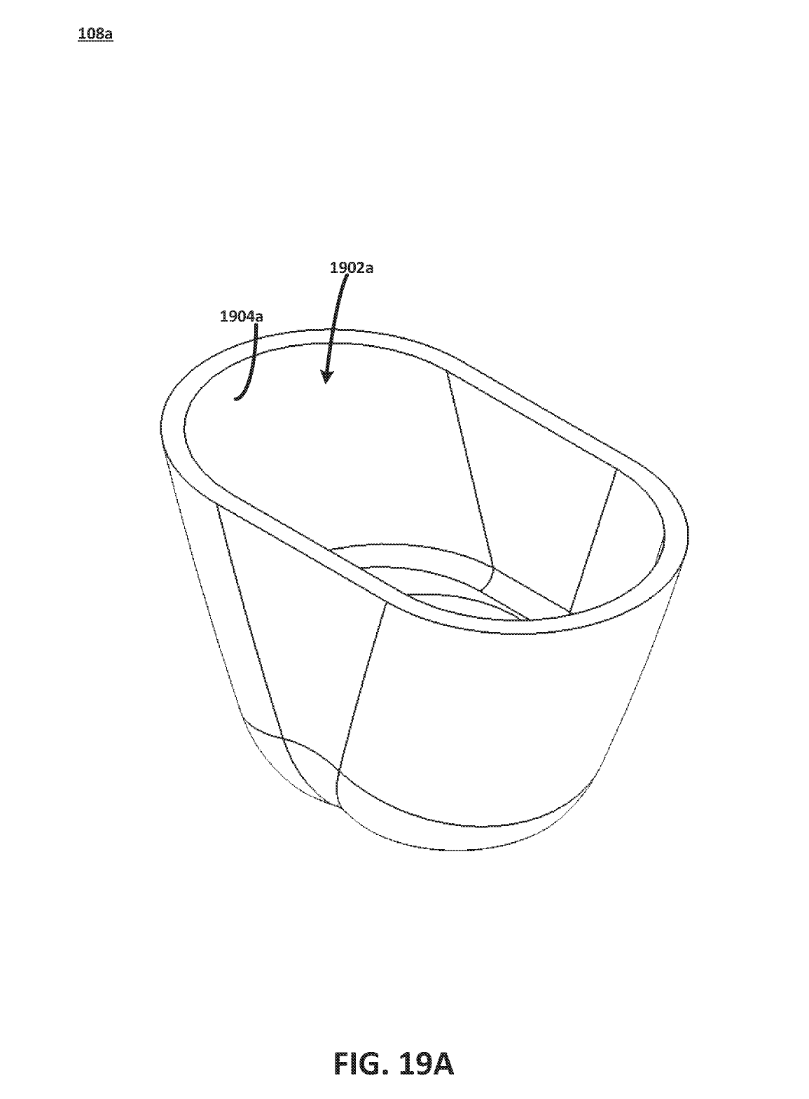

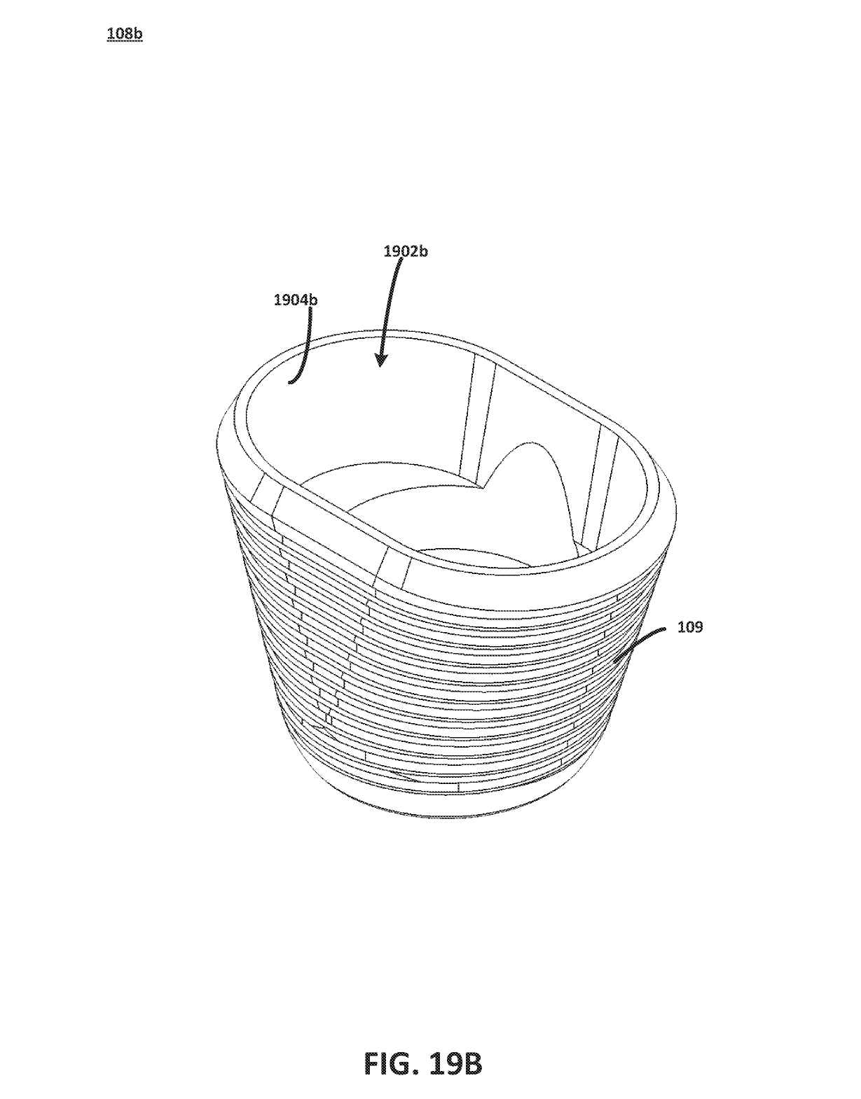

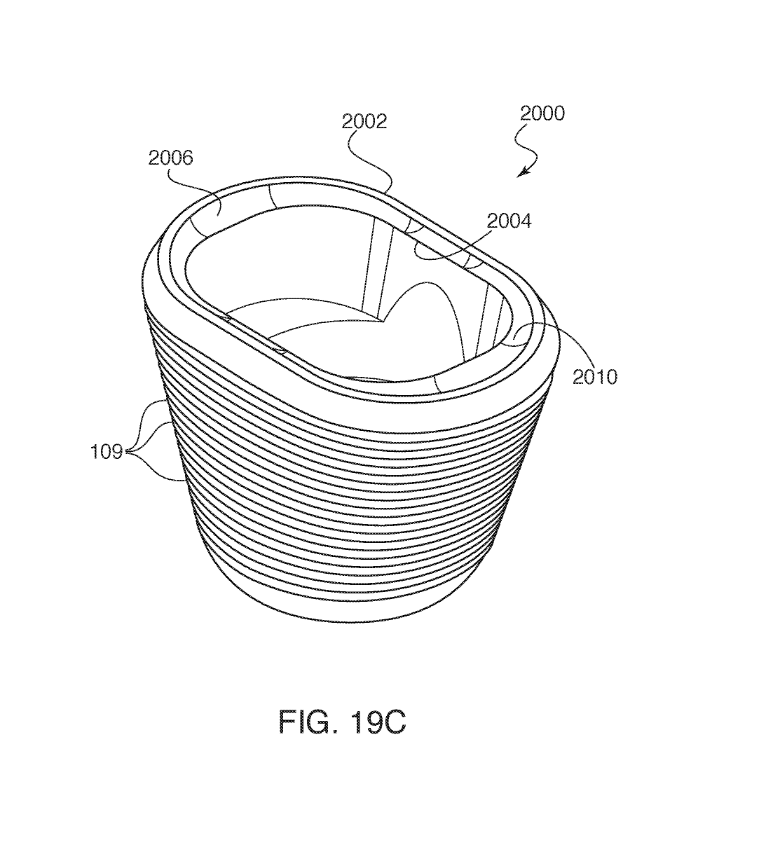

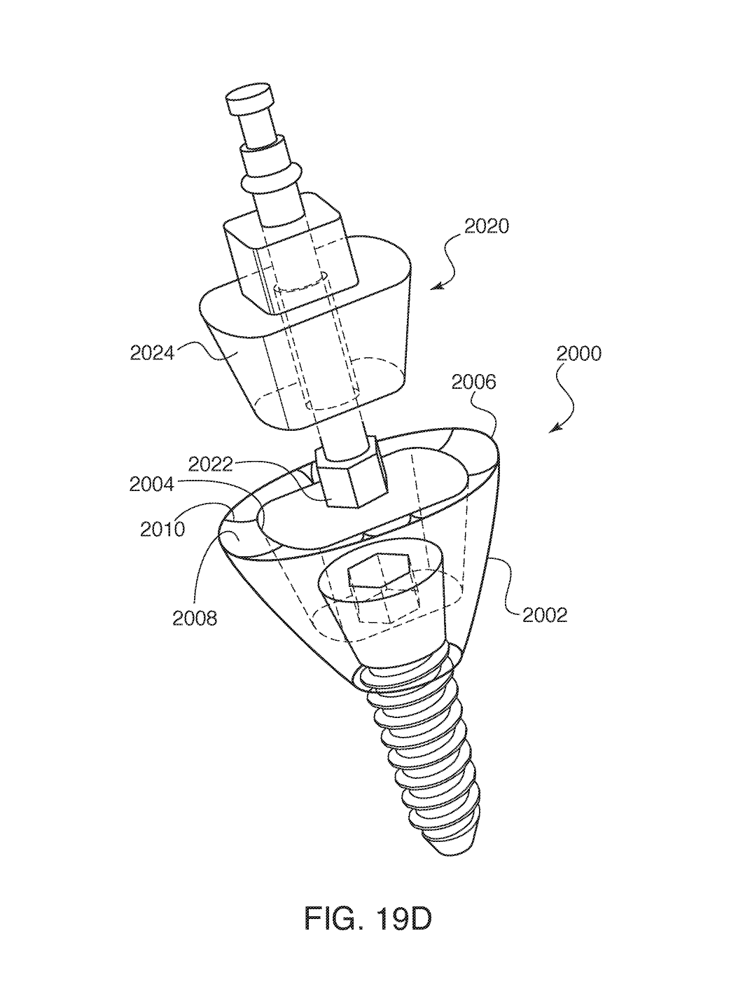

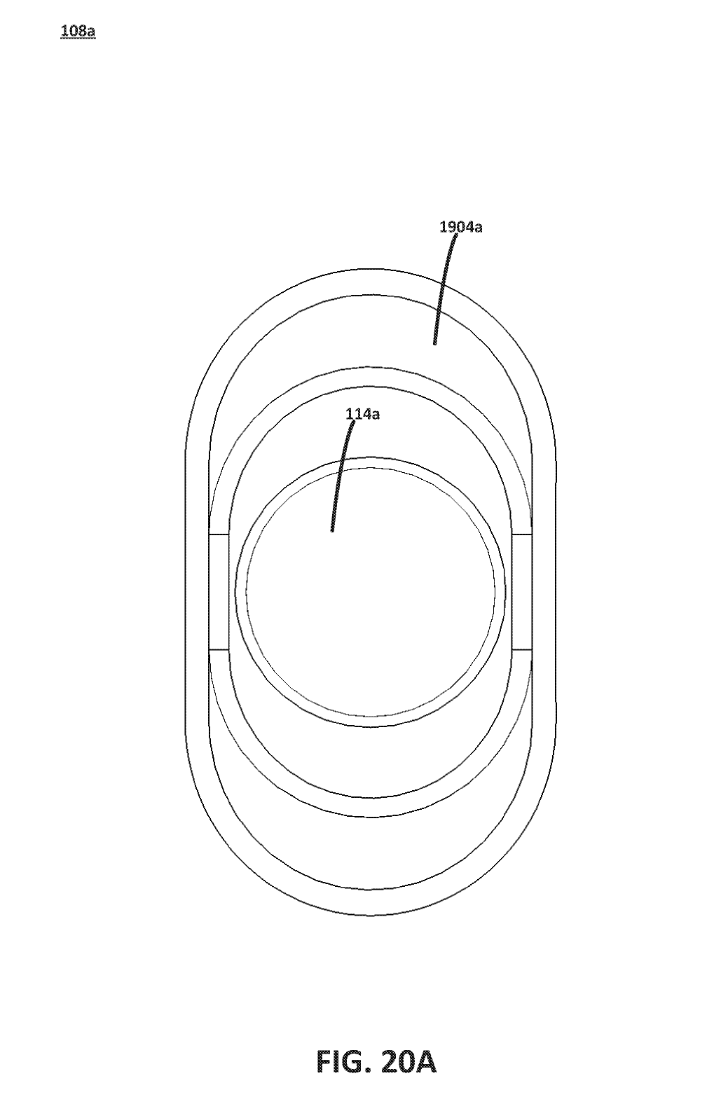

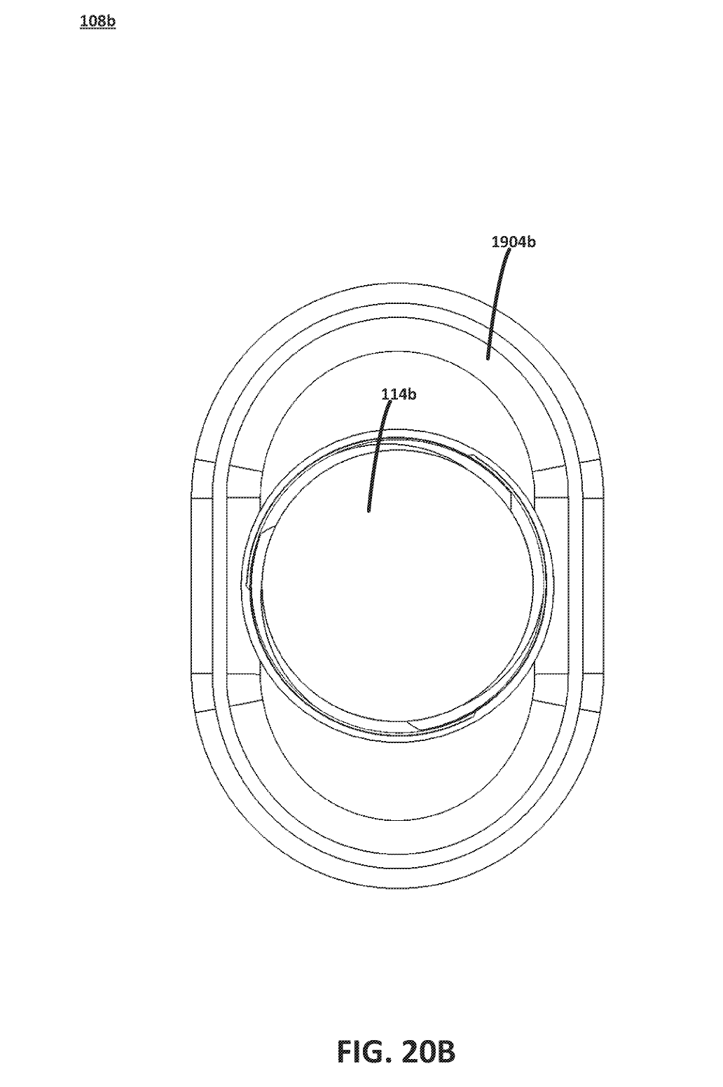

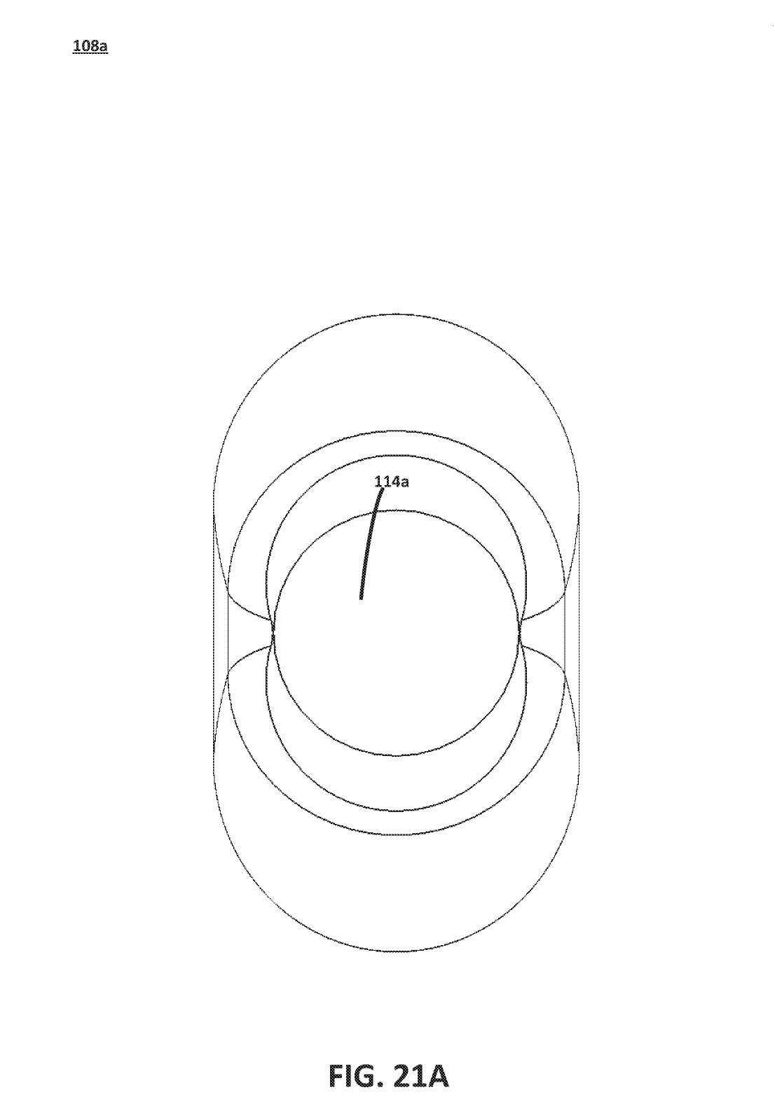

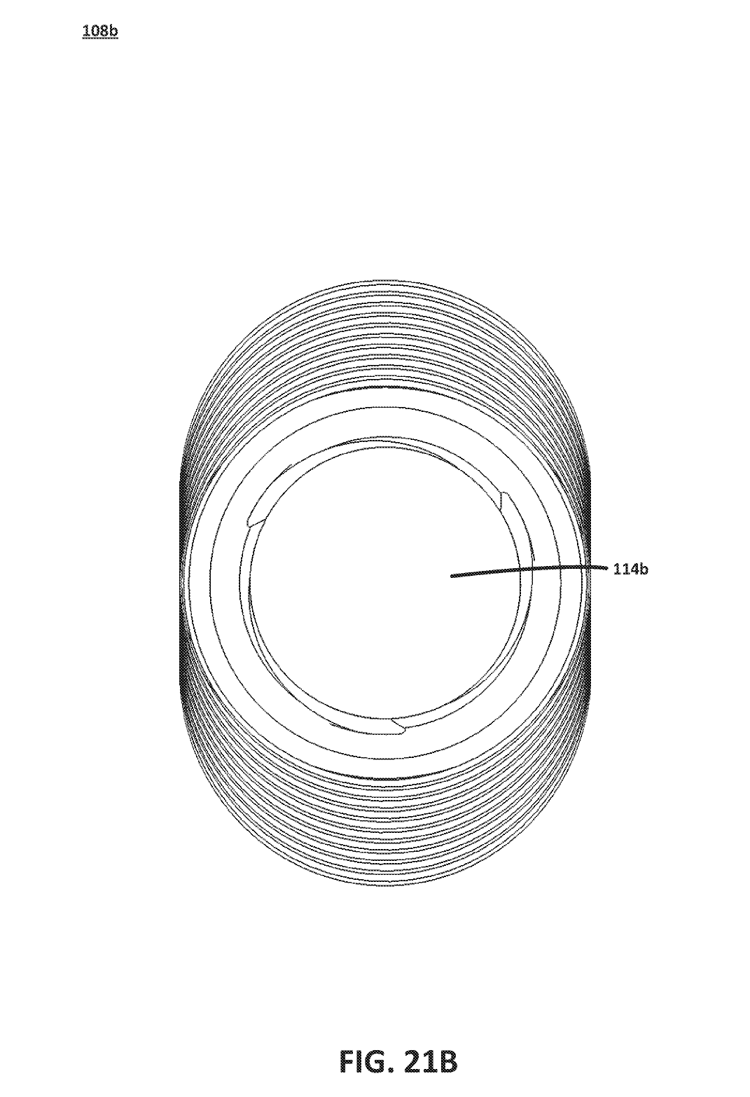

Referring now to FIGS. 19A-B through FIGS. 21A-B, multiple views of the endosseous implant body 106 are shown in accordance with the present disclosure. In these examples, and as mentioned above, a central passage 114 is formed within the base member 108. The central passage 114 is shaped so that the endosseous implant body 106 may be positioned thereto, and then torqued into place to rigidly secure the base member 108 to the jawbone 112. Other examples are possible. For instance, in some examples the central passage 114 is not formed within the base member 108. In this example, the base member 108 may be formed of a relatively soft tappable resin material where during implant the endosseous implant body 106 may “tap” the base member 108 to form the central passage 114 at various angles in situ.

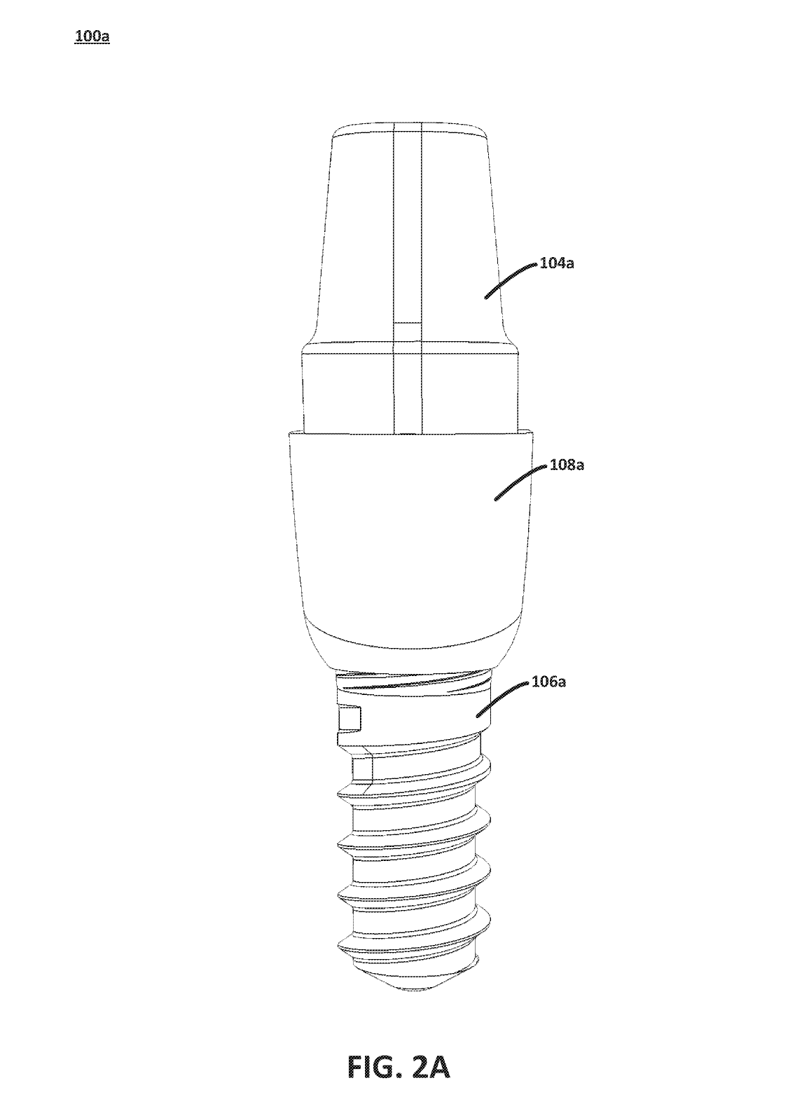

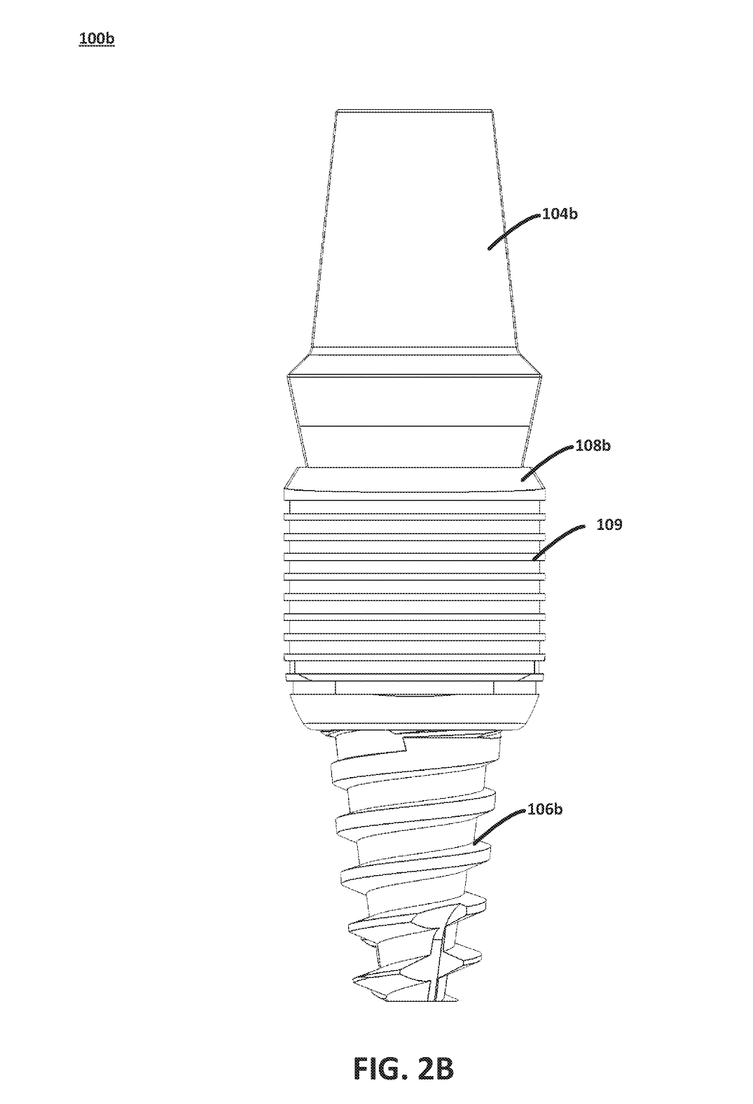

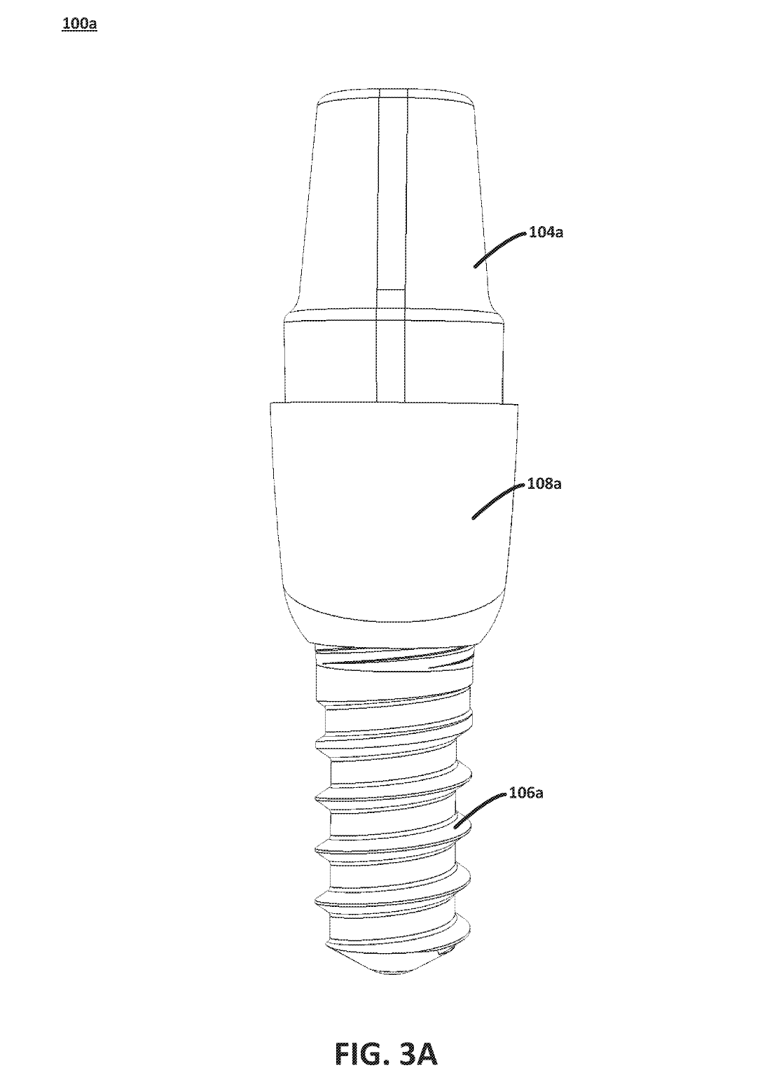

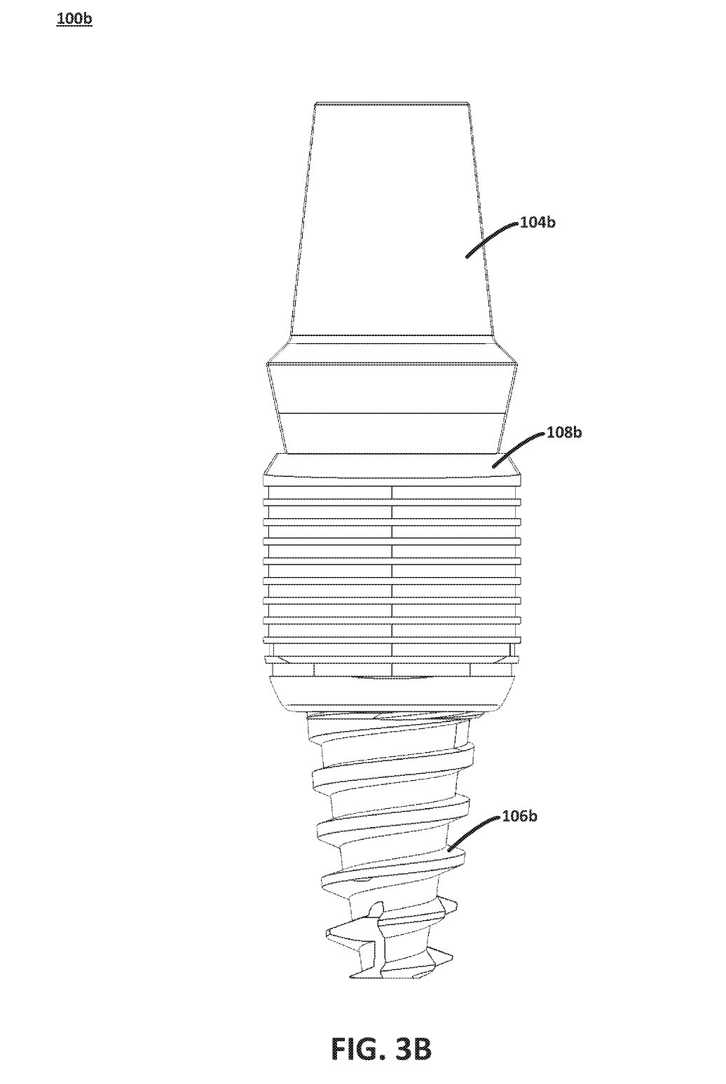

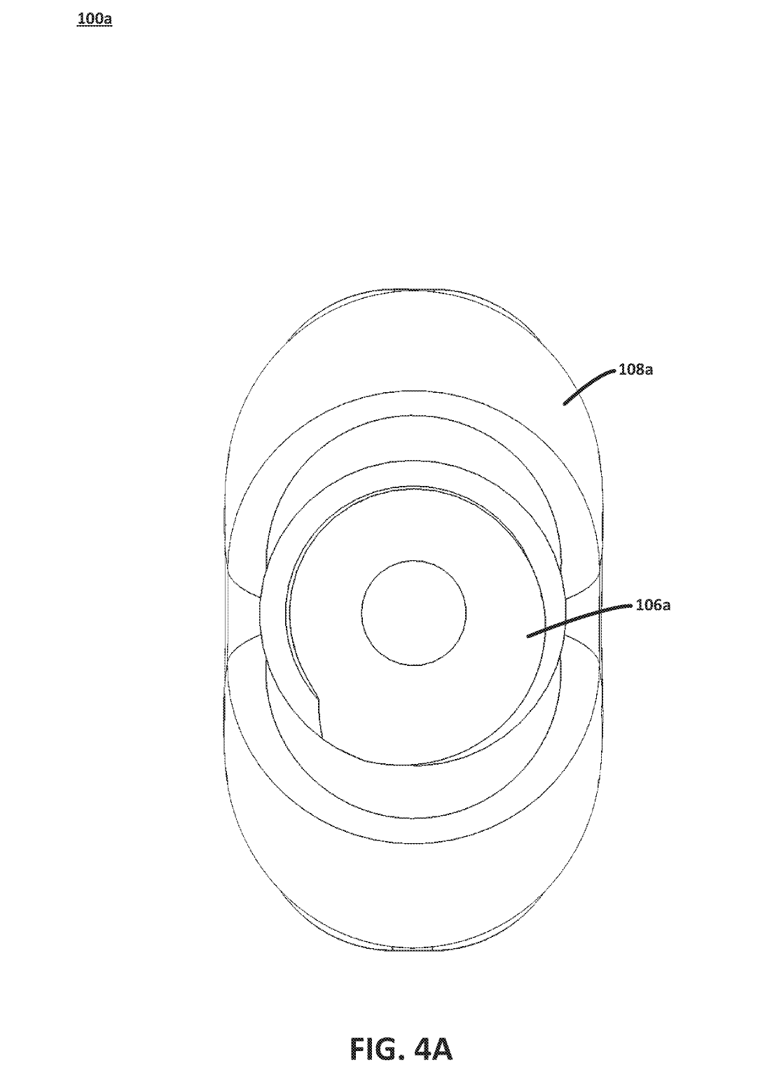

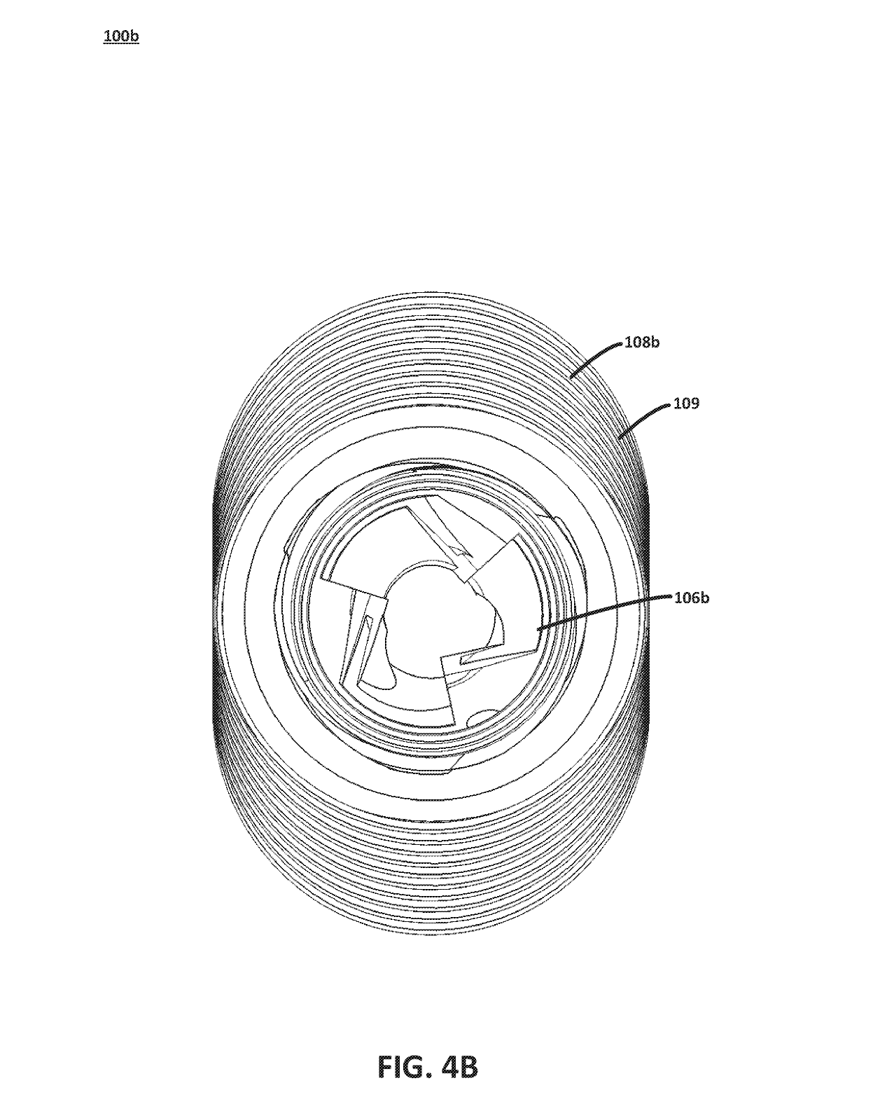

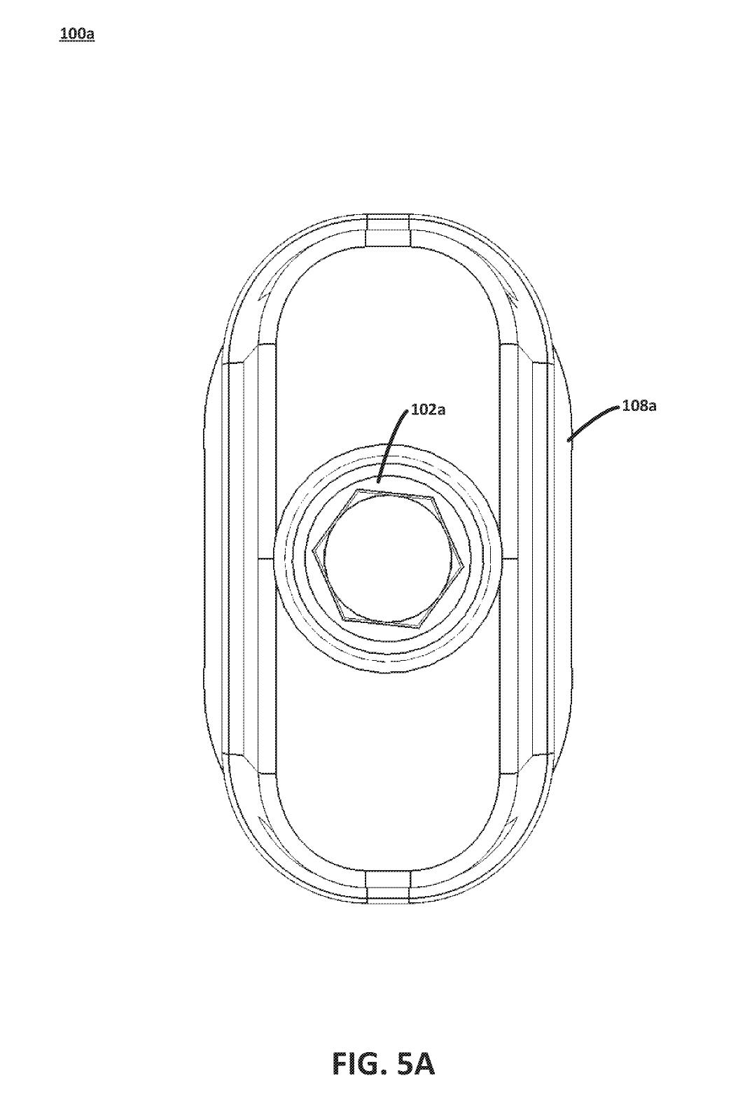

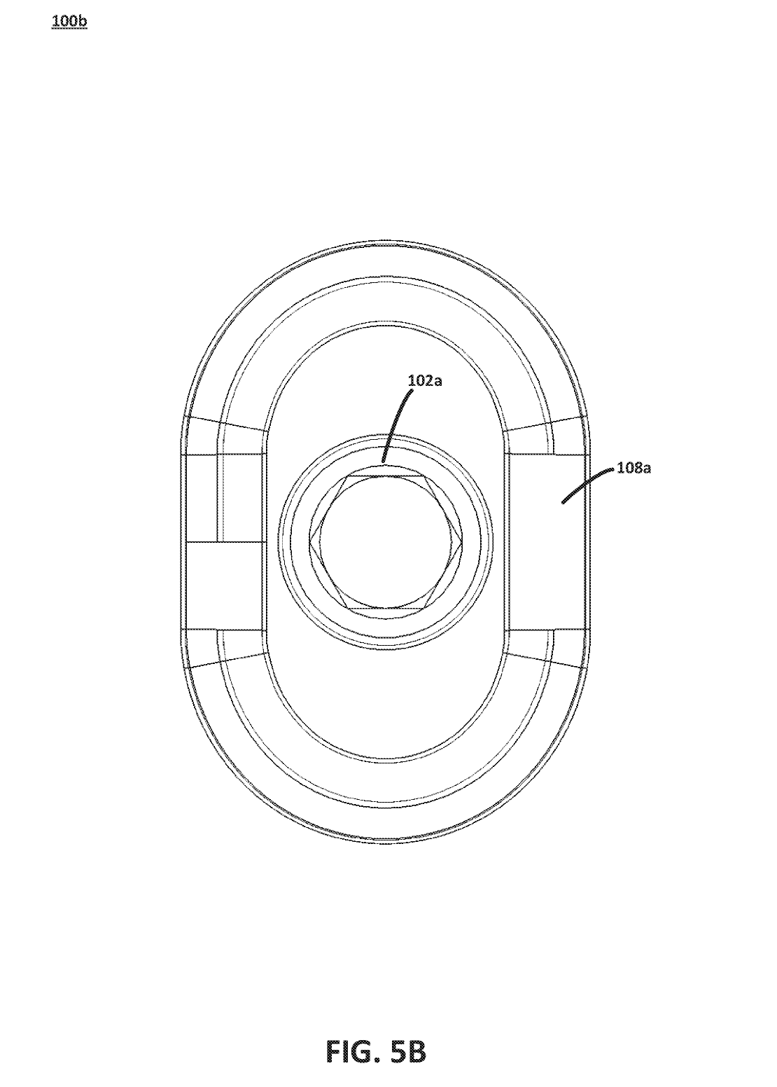

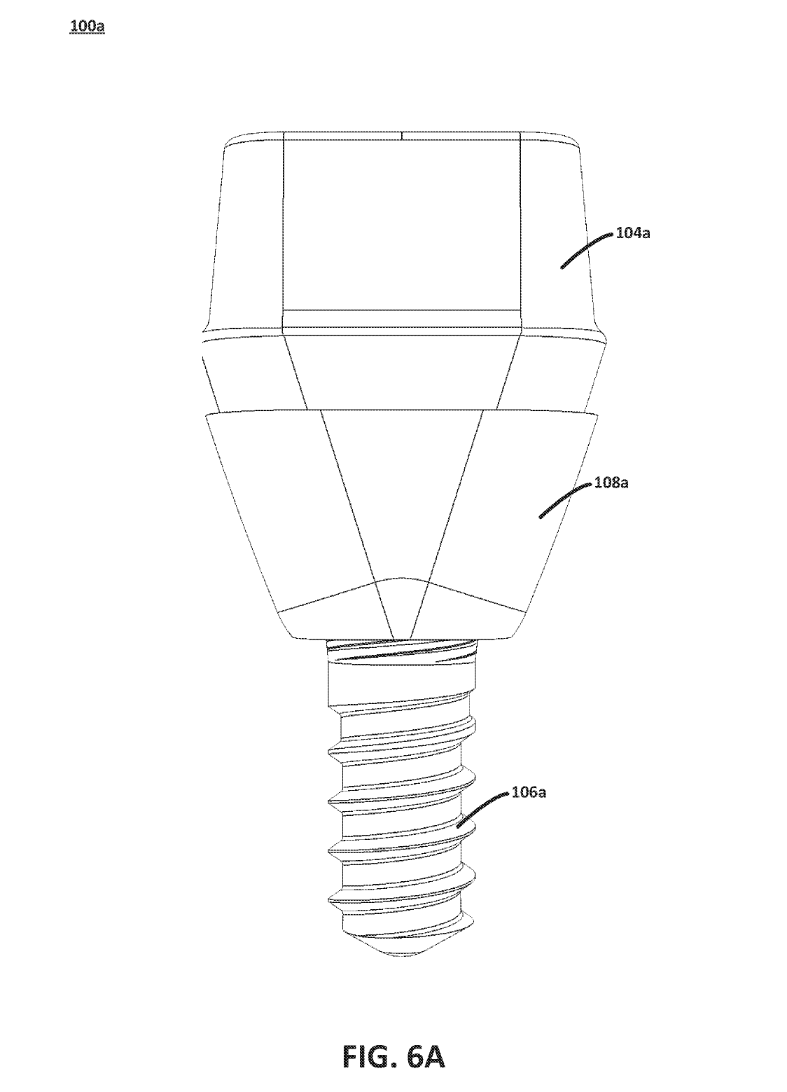

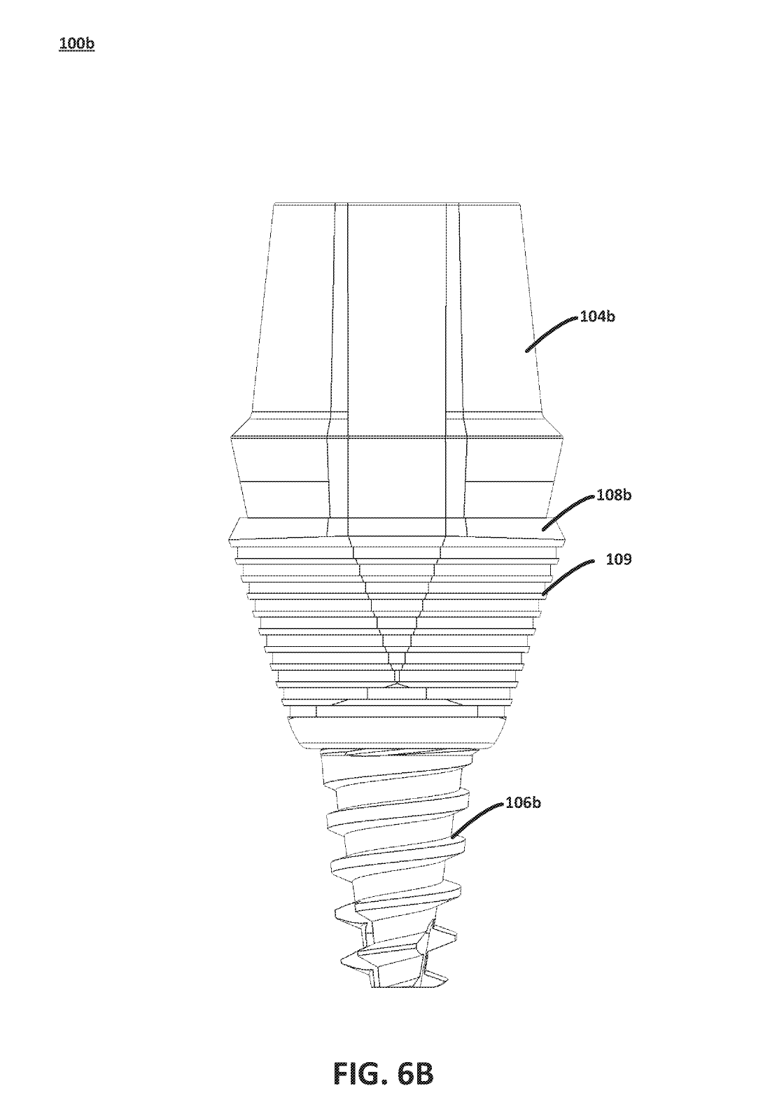

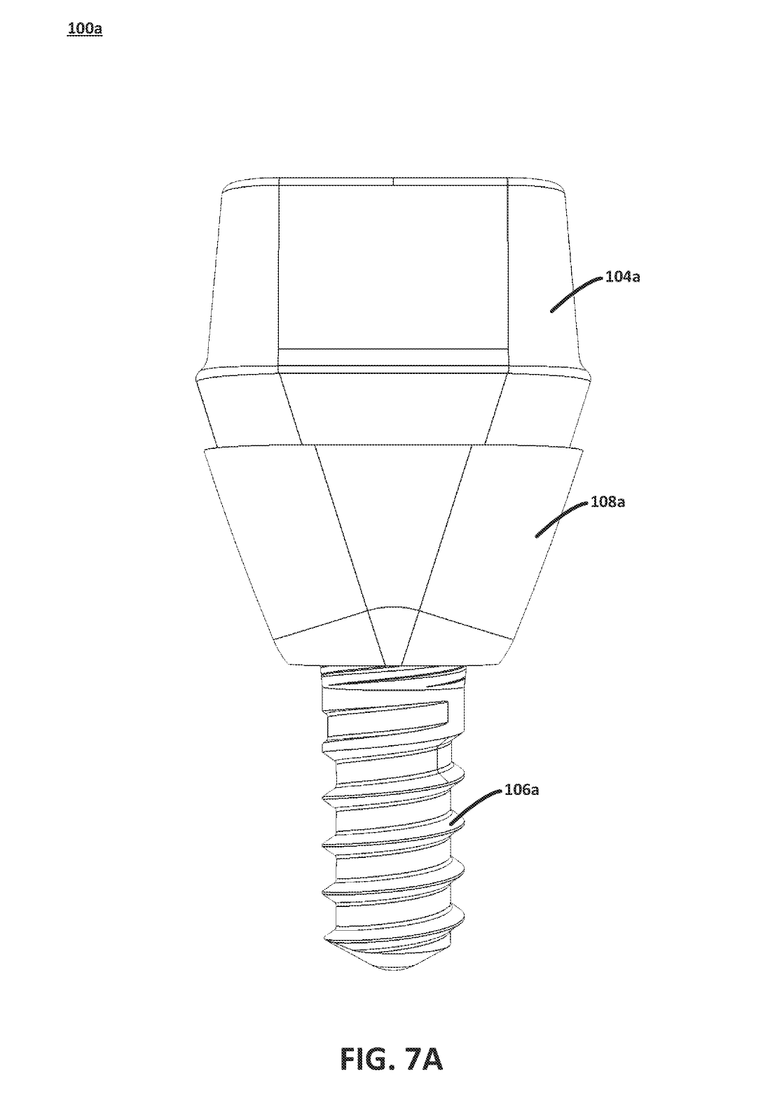

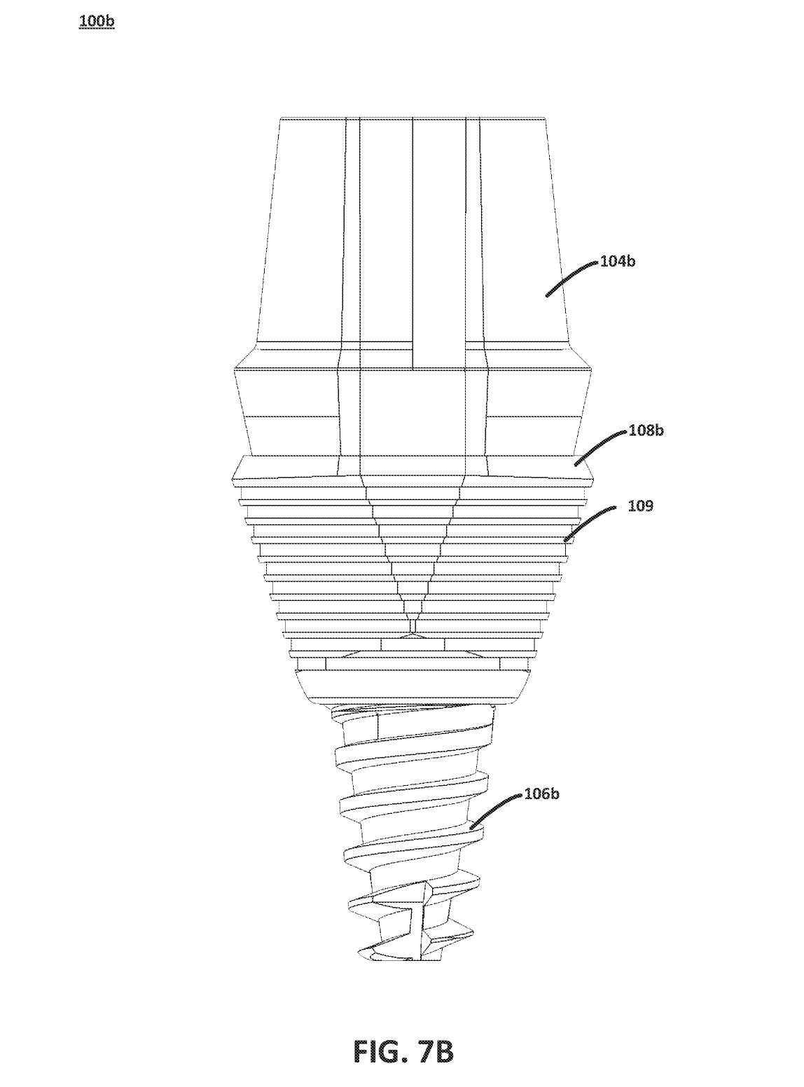

FIG. 19A shows a base member having an outer perimeter or cross section that is a “rounded” or “soft” rectangular shape. In some instances, this base member configuration may be referred to as a “basket.” As shown, the internal cross-section generally tracks the outer cross-section. The resulting basket is provided with a generally thin wall. FIG. 19B shows a base member 108 formed with external ridges 109 along the outer cross-section. Although the ridges 109 are illustrated as being generally stepped ridges, it should be understood that variations are possible and considered within the scope of this disclosure. For example, the actual shape of the ridges may include variations of the ridge shape based on information programmed into a CNC (computer numerical control) machine. For example, FIGS. 2B, 6B, and 7B all show various potential ridge shapes. The ridges may define a variety of square or triangular staircase-like configurations, which includes soft or rounded versions of these configurations. In general and in comparison with the base member 108 and the shape of the base member 108a&b as shown in FIG. 19A&B, the ridges 109 may improve bone integration (increased surface area and distribution of stress/load). See also FIG. 8B.

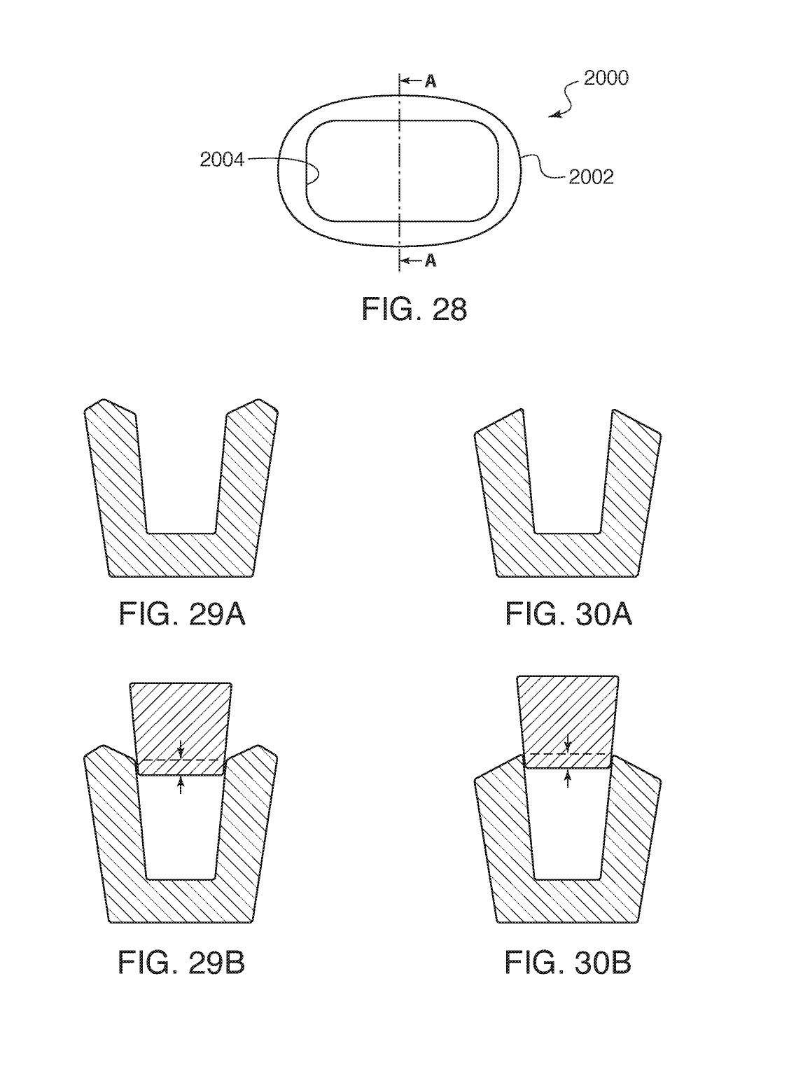

FIG. 19C illustrates an alternate base member 2000. Alternate base member 2000 is provided with a generally rounded, eccentric outer basket cross-section (or perimeter or shape) 2002. However, the internal cross-section or perimeter or shape 2004 differs slightly from the outer basket cross-section/shape 2002. In other words, the wall of the inner perimeter 2004 does not track exactly with the wall of the outer perimeter 2002. A schematic illustration of these differing inner and outer perimeters 2002, 2004 is illustrated by FIG. 28. The internal cutout shape 2004 is large enough to accommodate the implant body that is inserted. The internal shape may be provided with a taper, such as a Morse taper, in order to accommodate the shape of the tapered abutment that extends several millimeters into the interior to assure a leak-free fit. The internal shape may be any shape, shown here as essentially a modified ellipse in shape; in another example, it is of a polygonal or soft polygonal shape. In one specific example, the internal cross section 2004 is a “rounded” or “soft” rectangle (where each of the rectangle edges form a curved edge rather than a right angle edge). In another specific example, the internal cross section 2004 is an elongated oval-like shape. It should be understood, however, that other internal cross-sections are possible and considered within the scope of this disclosure. For example, the internal cross-section may be a “rounded” or “soft” triangle, square, rectangle, polygon, trapezoid, oval, or any other appropriate shape. In the examples shown, the internal and external perimeters do not define the same thickness around the entirety of the perimeter. This results in the wall 2006 of the alternate base member 2000 not being a constant thickness, but having at least some areas of increased thickness 2008 as compared to other portions of the wall. In some examples, the areas of increased thickness 2008 may be slight and not easily perceptible to the naked eye, but providing too large of a surface area along the upper surface of the base member may lead to possible infection sources. For example, if the outer perimeter 2002 is an eccentric oval, the inner perimeter 2004 may also be an eccentric oval shape that has a slightly different geometry from the outer perimeter.

FIG. 19C also illustrates that an upper surface of the base member basket 2000 may be provided with one or more sloped portions 2010. It is important to note that the upper surface of the base member can consist of a variety of shapes. It can initially start as a rounded rim that then slopes downwards as shown in FIG. 19C, that then intersects with the internal cross section portion 2004 of the base member. The upper surface of the base member basket can also slope upwards at an angle of up to approximately 75 degrees to intersect with the internal cross section portion of the base member. Exemplary illustrations of possible rim shapes are illustrated by schematic FIGS. 29 and 30. FIG. 29A illustrates a side cross sectional view of a base member embodiment having a two-stage angled upper face. FIG. 29B shows the base member of FIG. 29A with an abutment being positioned therein. FIG. 30A shows a side cross sectional view of an alternate base member embodiment having an upwardly angled upper face. FIG. 30B shows the base member of FIG. 30A with an abutment being positioned therein. Although these examples are shown, it should be understood that alternate rim shapes and options may be possible and are considered within the scope of this disclosure.

FIG. 19D illustrates a placement guide 2020, which functions as an anti-rotation tool. Placement guide 2020 may be provided with an implant driver hex 2022 and a head 2024. The head 2024 has an external cross-section that generally corresponds to the internal cross-section 2004 of the base member 2000. In use, the head 2024 may be used to help maintain the base member 2000 in place, while the endosseous implant body is driven into place. In use, the internal cross section portion 2004 of the base member is mated to the anti-rotation tool 2020 that is inserted into the internal portion. The placement guide 2020 may be secured via a lever arm (like a standard wrench) that holds the base member basket 2000 in place. The placement tool head 2024 has an internal passage that can accommodate rotation of an implant body until it is firmly in place, while the head 2024 maintains secure position of the base member basket 2000 in place, preventing its torque. Other anti-rotation placement guide configurations are possible and considered within the scope of this disclosure. The general goal is accommodate rotation of the implant body until it is snugly in place, while simultaneously holding the basket firmly in place without any rotation.

The base member 108 may further exhibit features complementary to the abutment member 104. For example, referring now additionally to FIGS. 22A-B which shows only the abutment member 104 positioned to the base member 108, the base member 108 includes a 1902(a,b) that is adjacent to the central passage 114. The receiver 1902 is defined by a tapered inner surface 1904(a,b) that is complementary to the tapered first portion 1302 of the abutment member 104. When the first portion 1302 of the abutment member 104 is positioned to the receiver 1902 of the base member 108, and the fastener 102 is positioned through the internal passage 116 formed within the abutment member 104 and torqued into place within the receiver 118 of the endosseous implant body 106, the abutment member 104 is rigidly secured to the base member 108. Such an implementation or fitting may advantageously make it easy for a physician to slip the abutment member 104 into the base member 108 with a correct or proper orientation, and also prevent the abutment member 104 from rotating with respect to the base member 108 due to the complementary oblong or oval geometry of these pieces. Other shapes of the base member 108 are possible.

The base member 108 may further exhibit features complementary to the abutment member 104. For example, referring now additionally to FIGS. 22A-B which shows only the abutment member 104 positioned to the base member 108, the base member 108 includes a 1902(a,b) that is adjacent to the central passage 114. The receiver 1902 is defined by a tapered inner surface 1904(a,b) that is complementary to the tapered first portion 1302 of the abutment member 104. When the first portion 1302 of the abutment member 104 is positioned to the receiver 1902 of the base member 108, and the fastener 102 is positioned through the internal passage 116 formed within the abutment member 104 and torqued into place within the receiver 118 of the endosseous implant body 106, the abutment member 104 is rigidly secured to the base member 108. Such an implementation or fitting may advantageously make it easy for a physician to slip the abutment member 104 into the base member 108 with a correct or proper orientation, and also prevent the abutment member 104 from rotating with respect to the base member 108 due to the complementary oblong or oval geometry of these pieces. Other shapes of the base member 108 are possible.

In some examples, the base member 108 may be formed of a zirconia or titanium or sapphire material. In some examples, dimensions of the top of the base member 108 (where 104 enters 108) may be in a range from about 4 mm to about 15.0 mm. Meanwhile, the bottom of the base member 108 (where 106 exits out of 108) may have dimensions in the range 2 millimeters to 10 millimeters. The length of 108 (measured from the top to the bottom of 108) ranges from 4 millimeters to 10 millimeters. Various other combinations of dimensions of these above cited ranges are possible.

Referring now to FIGS. 23A-D, only the endosseous implant body 106 is shown positioned to the base member 108. In particular, a side view 2302(a,b) along with a corresponding cross-section 2304(a,b) of the endosseous implant body 106 positioned to the base member 108 is shown. As mentioned above, the base member 108 includes features that are complementary to external features of the head portion 1604 of the endosseous implant body 106. In particular, an inner surface 2306(a,b) of the central passage 114 formed within the base member 108 includes a female thread 2308(a,b) that is complementary to the external thread 1614 of the head portion 1604 of the endosseous implant body 106. The female thread 2308 is also shown in FIGS. 8A-B. The inner surface 2306 of the central passage 114 is further tapered in a manner that is complementary to the above-mentioned taper of the head portion 1604 of the endosseous implant body 106. When the endosseous implant body 106 is positioned to the base member 108 as shown in FIGS. 23A-D, a friction seal or cold weld is formed at the interface between female thread 2308 of the base member 108 and the external thread 1614 of the head portion 1604 so that the joining of the endosseous implant body 106 to the base member 108 is achieved without fusion/heating at the mentioned interface of these two parts. Engagement between the external threads of the endosseous implant body 106 and the internal threads 2308 of the base member 108 can serve three purposes. First, the engagement can lock the two components into a fail-safe separation from loosening, while providing a way for disassembly should the implant components need to be removed from the patient. Second, the engagement draws the base implant/basket down to a snug vertical fit into the osteotomy. Third, once the threaded connections are fully engaged and the conical seal is achieved (which is leakproof due to the tapered neck of the base member), the endosseous implant body can be torqued until a maximum force is measured.

Referring still to FIGS. 23A-D, and as shown and discussed above in connection with FIGS. 16A-B, the external thread 1614a of the example endosseous implant body 106a of FIG. 16A and FIGS. 23A-B is immediately adjacent to the top edge 1611a of the endosseous implant body 106a, whereas the external thread 1614b of the example endosseous implant body 106b of FIG. 16B and FIGS. 23C-D is offset from the top edge 1611b of the endosseous implant body 106b. Therefore, one difference between the endosseous implant body 106a and the endosseous implant body 106b is at the head region near the keyed aperture 1610(a-b).

Specifically, with the endosseous implant body 106a, the entire head portion 1604a (see FIG. 16A) exhibits the external thread 1614a that threads with the internal thread 2308a of the base member 108a, and the tapered head portion 1604a (that exhibits the external thread 1614a) is matched with the tapered inner surface 2306a of the central passage 114a of the base member 108a (that exhibits the internal thread 2308a) to form a friction fit or cold weld. Specifically, engagement of the external thread 1614a and the internal thread 2308a serves to maintain this friction fit or cold weld so that over time there is no micro-leakage of fluids between this interface. See also FIG. 8A and above discussion.

In contrast, with the endosseous implant body 106b, the entire head portion 1604b (see FIG. 16b) does not exhibit the external thread 1614b that threads with the internal thread 2308b of the base member 108a. Only a portion of the head portion 1604b includes the external thread 1614b. Also, the external thread 1614b is not included on a tapered section of the head portion 1604b but on any straight, cylindrical section near or adjacent to tapered section 1613b as shown in FIG. 9B and FIG. 16B. Advantageously, and as mentioned in above, this is done to facilitate manufacturing of the endosseous implant body 106 and the base member 108 because it is easier to manufacture threads on straight section, rather than tapered sections. However, the endosseous implant body 106b still exhibits a tapered section to provide the friction fit or cold weld similar to the endosseous implant body 106a of FIG. 9A for example. Further, the external thread 1614b may be placed above or below the tapered section 1613b, so long as that thread is able to thread with the thread 2308a of the base member 108b to form the friction fit or the cold weld.

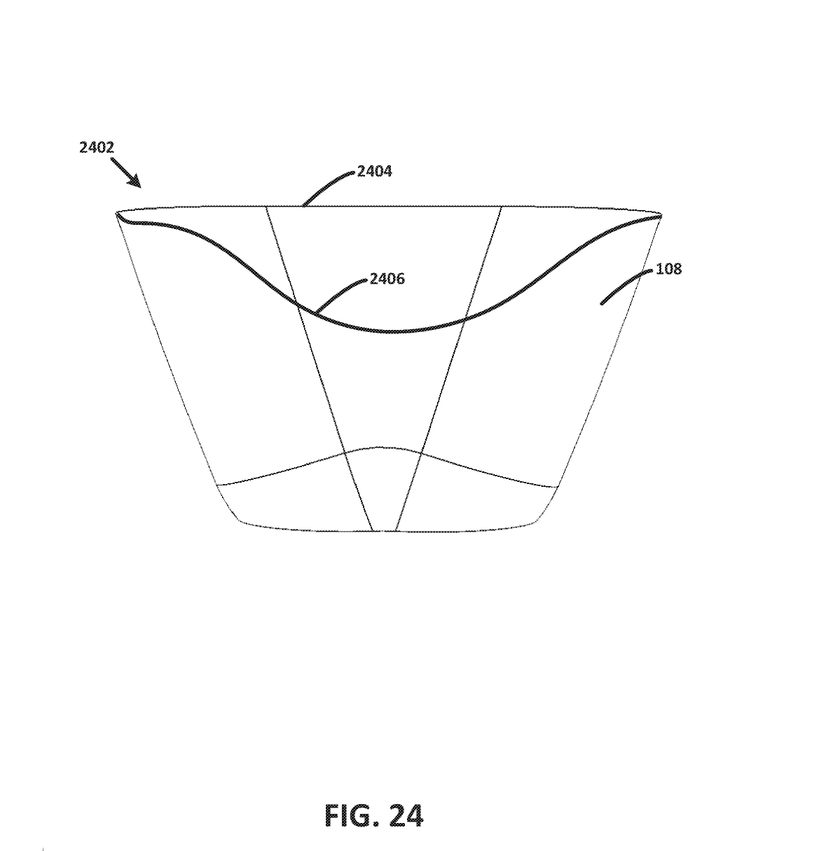

Referring now to FIG. 24, a side view 2402 of the base member 108 is shown. In this example, a periphery 2404 of the base member 108 is shown as approximately or about flat when viewed from at least the side. Many other examples are possible. For example, the periphery 2404 of the base member 108 may be machined in situ or prior to implant so as to exhibit a non-flat shape when viewed from at least the side, as shown by periphery 2406 in FIG. 24. In this example, the top portion of the base member 108 appears saddle-shaped due to the shape of the periphery 2406. Many other examples are possible, where the profile of the top portion of the base member may be formed as desired, to exhibit an irregular shape for example that may be similar to the profile or shape of the gum line or bone line of a patient at or near the implant site.

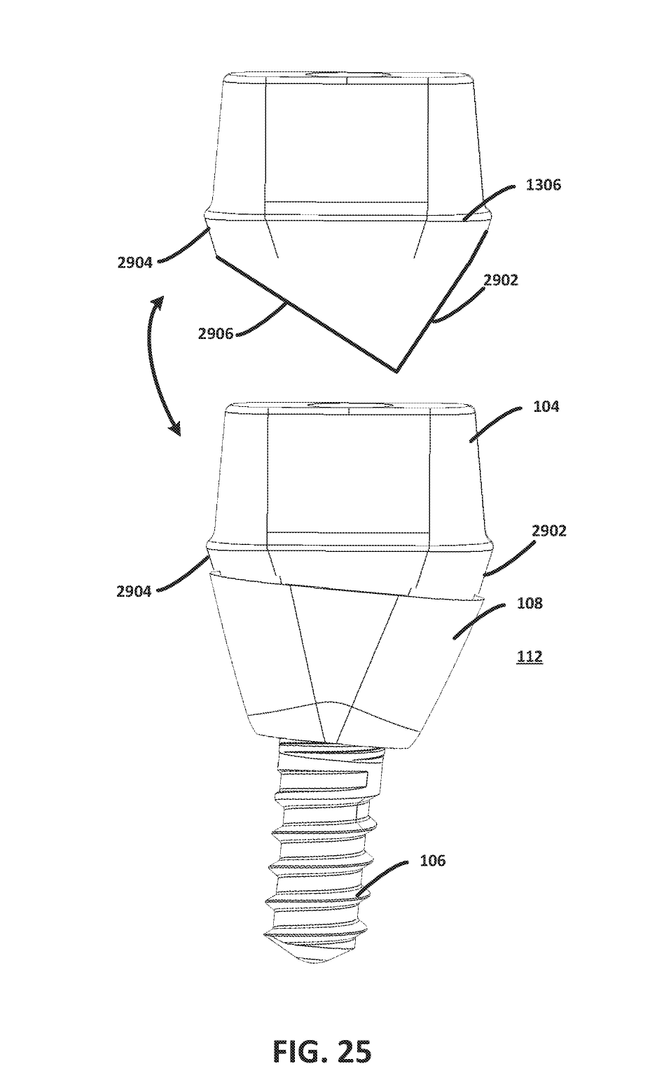

Referring now to FIG. 25, a modification of the abutment member 104 is shown in accordance with the principles of the present disclosure. In particular, the abutment member 104 is formed to exhibit a long side 2902 and a short side 2904. Such an implementation may advantageously permit a crown (not shown) when positioned to the abutment member 104 to be orientated substantially “upright” in a desired position for aesthetic and/or practical (e.g., chewing) purposes. For example, as shown in FIG. 25, the base member 108 may be implanted to the jawbone 112 at an angle, due to the natural shape of the jawbone at the implant site or for some other reason. The irregular shape of the abutment member 104 may compensate for the angle exhibited by the base member 108 as shown in FIG. 25. It is contemplated that the abutment member 104 may be machined, molded, 3D printed, etc., to exhibit the irregular shape at time of implant (e.g., by machining bottom surface 2906), or may be selected from any of a number of different prefabricated abutment members formed to exhibit an irregular shape similar to that shown in FIG. 25.

As may be understood from the foregoing, a dental implant is disclosed whereby an eccentrically-shaped osteotomy cavity is formed in jawbone and then an eccentrically-shaped base member of the implant is positioned into the cavity. The base member serves as a platform to secure an eccentrically-shaped abutment member of the implant that in turn receives a dental restoration, such as a crown or denture. Advantageously, such an implementation may make it easy for a physician to slip the abutment member into the base member with a correct or proper orientation, and also prevent the abutment member from rotating with respect to the base member due to the complementary oblong or oval geometry of these pieces. Additionally, various features of the pieces or parts of the dental implant may improve bone integration and in general fit together with precision, and may in general be surface treated.

For example, the above-mentioned ridges 109 are optional but may serve to improve bone integration (increased surface area and distribution of stress/load). Also, surfaces or surface area in contact with bone, e.g., surface associated with ridges 109 and/or threads of the endosseous implant body 106 may be surface treated. Such surface treatments may be in addition to or instead of the external ridges 109. These surface treatments may help improve bone integration. This may be accomplished in a number of ways. One example includes additive processes, such as plasma spraying or other types of coating. Another example includes subtractive processes, such as acid-washing or bead blasting. A further surface treatment that is possible includes a layer of polyether ether ketone (PEEK) applied to the external surface area in contact with bone. Furthermore, certain part mating areas such as between eccentric surfaces of the abutment member 104 and the base member 108, and surfaces between the base member 108 and endosseous implant body 106, utilize a tapered angle so the parts may “cold weld” to tightly lock the pieces together. Advantageously, this may distribute forces more evenly across two pieces, and also create a seal at a joint to prevent bacterial micro-leakage.

It should be understood that this disclosure relates to components that may be used with various jaw sizes. For example, the base member, the endosseous implant body, the abutment member, and/or the fasteners described herein may have any appropriate diameter, length, taper, or any other dimensions or geometries that allow the system to be used with various jaw sizes. It should be understood that the disclosure may be sized down for use with children and/or sized up for use with particularly large jaw sizes, and by implication, including the full range of tooth sizes from molars to front teeth.

Additionally, although multiple components are described for use in cooperation with one another, it should be understood that it is possible to provide one piece version of the disclosed implant that may be pressed into the pre-drilled osteotomy and into the bone, rather than requiring screws and a multipart implant. In certain embodiments, a one-piece press fit implant having the outer eccentric shapes described herein, may be useful. A one-piece press fit implant may be used for both anterior and posterior teeth. Various sizes are possible and considered within the scope of this disclosure.

In the one-piece version, it is envisioned that the implant body may still be provided. The internal (female) threads of the implant body accommodate the abutment member screw. The implant body may be provided as having a shorter length, such that it does not extend out of the bottom of the base member. The implant body is designed to be threaded into the bottom of the base member. The base member may be closed off at the bottom (without the need for a cap screw or plug). In an alternate embodiment, if a standard base member (with a hole in its base) is used, a cap screw or plug may be used to secure the lower opening. The general goal is to preserve the ability to use a standard base member without alteration, use a shorter implant body, and have the ability to enclose the base member with a cap screw or plug.

An alternate variation of this disclosure provides a “plug” that may be inserted at the bottom of the base member basket. The plug may be provided with internal threading. Absent threading, the abutment may be press fit or friction fir into the base member. This may be particularly useful for patients having shallow bone where there is inadequate bone depth to accommodate a threaded implant screw. The base implant basket may be friction fit into place within the patient's bone. This may also be useful in instances in which the threaded implant screw would encounter a nerve or sinus. The plug may screw into an opening in the base member basket. The plug may be press fit into place to cover the opening. The plug may be cold welded into place to cover the opening. In other examples, an opening is not provided in the base member basket at all but the lower portion forms a continuous solid base, providing a design that is intended for press fit use only.

The implants disclosed herein may be manufactured using any appropriate methods. In certain examples, powdered metal sintering using 3-D Selective Laser Sintering or SLS printing as possible.

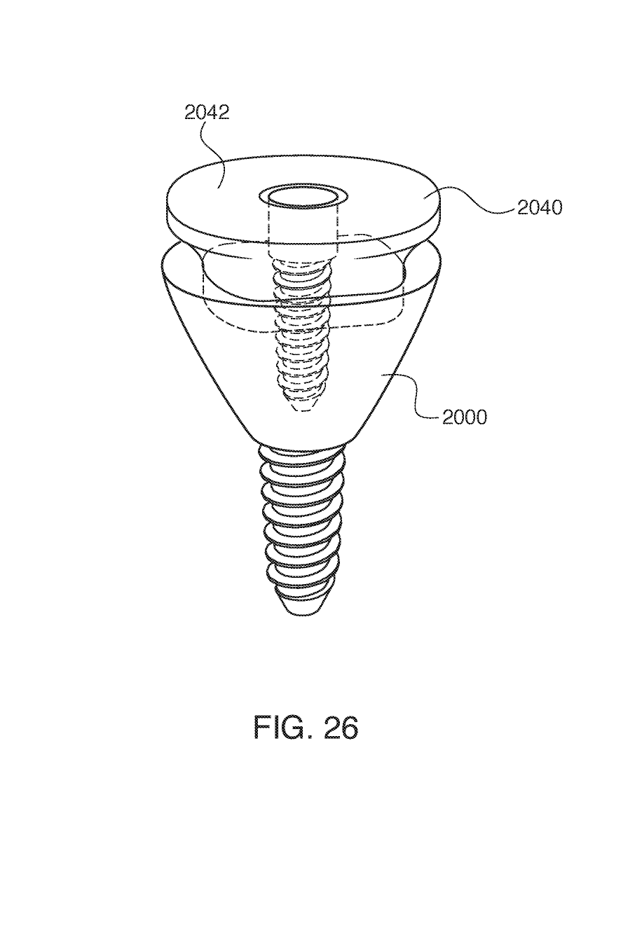

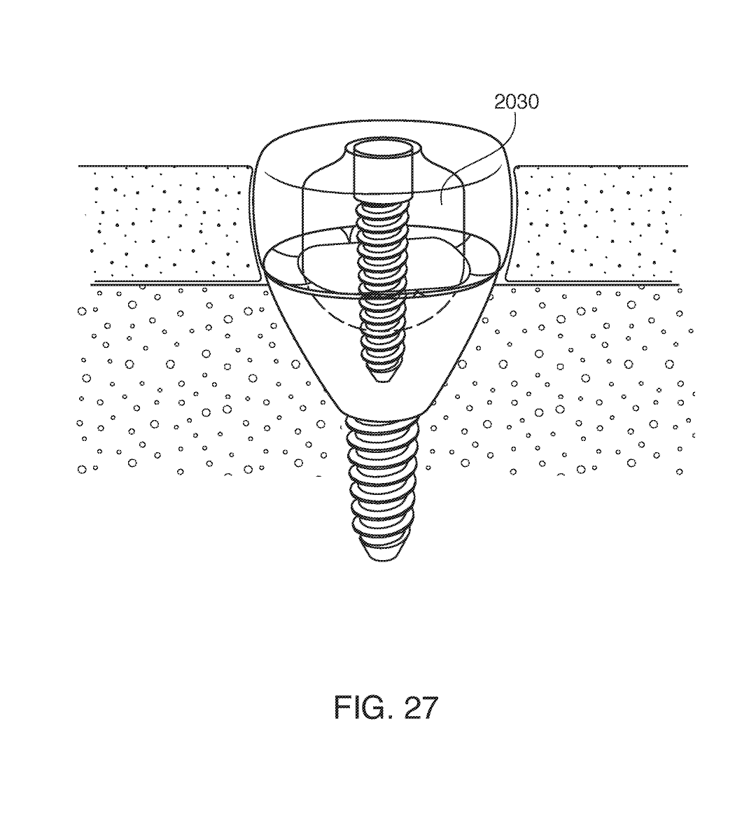

As illustrated by FIGS. 26 and 27, it is also possible to provide accompanying healing features. FIG. 26 illustrates a healing cap 2040. The healing cap 2040 is designed to fit in a low profile configuration with respect to the base member in order to prevent micro leakage. In some examples, an upper portion 2042 of the healing cap is flat and fits flush with respect to an upper portion of the base member. The healing cap 2040 is intended to be left in place for several months to promote healing. The healing cap 2040 is removed and replaced with the tissue former 2030 (described below).

FIG. 27 illustrates the use of a tissue former 2030. The tissue former 2030 is used prior to fitting the abutment member to the base member. The tissue former 2030 is used to create a “well” of tissue to form around the gum tissue. The purpose of the tissue former 2030 is to allow sub gingival placement of the final abutment without impinging on the gum tissue.

A dental implant system or assembly and a method for implanting the same are contemplated and claimed and, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Additionally, the methods, systems or assemblies as discussed above are examples. Various configurations may omit, substitute, or add various method steps or procedures, or components as appropriate. For instance, in alternative examples, the methods may be performed in an order different from that described, and/or various stages may be added, omitted, and/or combined.

What is claimed is:

1. A dental implant assembly, comprising:
a base member adapted for placement into an opening in jawbone, wherein the base member includes an internal recess and a through-hole that extends from the recess through an end of the base member, and wherein the through-hole includes an internal screw thread that extends along a length of the through-hole, the base member including an external surface shape an internal surface shape, wherein the external surface shape differs from the internal surface shape;
an endosseous implant body adapted for insertion into the through-hole, wherein the endosseous implant body includes an external screw thread to engage the internal screw thread of the through-hole, and includes a separate external screw thread to engage a patient's jawbone to secure the base member in the opening;
an abutment member adapted for placement into the recess of the base member, wherein the abutment member includes an internal passage that extends between a top end and a bottom end, and wherein the bottom end exhibits a shape to mate with the recess of the base member; and
a securing screw adapted for insertion into the internal passage of the abutment member and into a head portion of the endosseous implant body, wherein the securing screw includes an external screw thread to engage an internal screw thread of the head portion to secure the abutment member to the base member.

2. The dental implant assembly of claim 1, wherein the base member is basket-shaped and non-circular or eccentric in cross-section and the internal recess has a polygonal, soft polygonal shape, or oval shape.

3. The dental implant assembly of claim 1, wherein the internal screw thread of the through-hole includes a plurality of individual internal screw threads.

4. The dental implant assembly of claim 1, wherein an external surface of the base member includes a plurality of concentric ridges.

5. The dental implant assembly of claim 1, wherein an external surface of the head portion of the endosseous implant body is tapered to match a taper of the through-hole of the base member.

6. The dental implant assembly of claim 1, wherein a length of the endosseous implant body along the separate external screw thread is tapered.

7. The dental implant assembly of claim 1, wherein pitch of the external screw thread to engage the internal screw thread of the through-hole is different than pitch of the separate external screw thread to engage jawbone to secure the base member in the opening.

8. The dental implant assembly of claim 1, wherein the separate external screw thread to engage jawbone to secure the base member in the opening includes at least one leading and open edge.

9. The dental implant assembly of claim 1, wherein the abutment member is plug-shaped and an outer surface of the abutment member has a polygonal, soft polygonal, or oval shape.

10. The dental implant assembly of claim 1, wherein the internal passage of the abutment member includes an internal screw thread that is complementary to the external screw thread of the securing screw.

11. The dental implant assembly of claim 1, wherein a head portion of the securing screw includes a keyed-aperture and a plurality of torque-bearing surfaces.

12. A dental implant assembly, comprising:
a base member adapted for placement into an opening in jawbone, wherein the base member includes an internal recess and a through-hole that extends from the internal recess through an end of the base member;
an abutment member adapted for being positioned into the internal recess of the base member, wherein the abutment member includes an internal passage that extends between a top end and a bottom end, and wherein the bottom end exhibits a shape to at least partially mate with the recess of the base member; and
a plug adapted for insertion into the through hole and internal passage.

13. The dental implant assembly of claim 12, wherein the through-hole comprises an internal threaded opening and further comprising an endosseous implant body adapted for insertion into the through-hole, wherein the endosseous implant body includes an external screw thread to engage the internal threaded opening.

14. The dental implant assembly of claim 12, wherein the endosseous implant body comprises a separate external screw thread to engage a patient's jawbone to secure the base member in the opening.

15. The dental implant assembly of claim 12, wherein the internal recess is configured to receive a head of a placement anti-rotation guide.

16. A dental implant assembly, comprising:
a base member adapted for placement into an opening in jawbone, wherein the base member includes a recess and a through-hole that extends from the recess through an end of the base member;
an endosseous implant body adapted for insertion into the through-hole, wherein the endosseous implant body includes an external screw thread to engage a patient's jawbone to secure the base member in the opening;
an abutment member adapted for placement into the recess of the base member, wherein the abutment member includes an internal passage that extends between a top end and a bottom end, and wherein the bottom end exhibits a shape to mate with the recess of the base member; and
a securing screw adapted for insertion into the internal passage of the abutment member and into a head portion of the endosseous implant body, wherein the securing screw includes an external screw thread to engage an internal screw thread of the head portion to secure the abutment member to the base member.

17. The dental implant assembly of claim 16, wherein the endosseous implant body is secured in place with respect to the base member via cementing or cold welding.

18. The dental implant assembly of claim 16, wherein the base member further comprises a through-hole with an internal screw thread that extends along a length of the through-hole, and wherein the endosseous implant body further an upper external screw thread configured to engage the internal screw thread of the through-hole for securement therebetween.

19. The dental implant assembly of claim 1, wherein the base member comprises a sloped or angled upper portion.

20. The dental implant assembly of claim 1, further comprising a healing cap or a tissue former or both.
